(19) United States
(12) Patent Application Publication
(10) Pub. No.: US 2015/0318568 A1
(43) Pub. Date: Nov. 5, 2015

(54) High Specific Energy Aqueous Flow Battery

(71) Applicant: Ftorion, Inc., Boston, MA (US)

(72) Inventor: Yuriy V. Tolmachev, Boston, MA (US)

(73) Assignee: Ftorion, Inc.

(21) Appl. No.: 14/697,690

(22) Filed: Apr. 28, 2015

Related U.S. Application Data
(60) Provisional application No. 61/986,830, filed on Apr. 30, 2014.

(51) Int. Cl. H01M 8/20; H01M 8/02; H01M 8/18

(52) U.S. Cl. CPC H01M 8/20; H01M 8/188; H01M 8/0265; H01M 8/186

(57) ABSTRACT

A discharge unit generates electric power and a discharge fluid by simultaneously transferring acidic protons from a reducer fluid at a negative electrode of an electrolyte-electrode assembly (EEA) to an oxidant fluid at a positive electrode of the EEA through an electrolyte, and simultaneously transferring electrons from the negative electrode to the positive electrode through an external electric circuit. A neutral oxidant fluid is stored on board and is supplied to the discharge unit without prior on-board acidification. A regeneration system converts the discharge fluid into an alkaline discharge fluid using a base, splits the alkaline discharge fluid into a reducer and an intermediate oxidant in a splitting-disproportionation reactor, and releases the reducer and a base, while producing an aqueous multi-electron oxidant (AMO) by disproportionating the intermediate oxidant with the base. The regenerated AMO and reducer are supplied to the discharge unit for power generation.

### CROSS-REFERENCE TO RELATED APPLICATIONS

This application claims priority to and the benefit of provisional patent application No. 61/986,830 titled “High Specific Energy Aqueous Flow Battery”, filed in the United States Patent and Trademark Office on Apr. 30, 2014. The specification of the above referenced patent application is incorporated herein by reference in its entirety.

### BACKGROUND

The method and system disclosed herein, in general, relates to an electrochemical flow battery. More specifically, the method and system disclosed herein relates to a high specific energy aqueous flow battery that discharges in an ignition regime without addition of an acid to an oxidant.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

A method for producing electric power from an aqueous multi-electron oxidant (AMO) and a reducer and for simultaneously generating a discharge fluid is provided. The method disclosed herein provides a discharge system comprising one or more forms of a reducer fluid, a neutral oxidant fluid, and a discharge unit. The method disclosed herein facilitates discharge in the discharge unit for producing electric power from the neutral oxidant fluid comprising one or more forms of the AMO, and from the reducer fluid comprising one or more forms of the reducer, for example, hydrogen. The facilitation of the discharge comprises simultaneously transferring acidic protons from the reducer fluid at a negative electrode of the electrolyte-electrode assembly to the neutral oxidant fluid at a positive electrode of the electrolyte-electrode assembly through an electrolyte of the electrode-electrolyte assembly, and simultaneously transferring electrons from the negative electrode to the positive electrode of the electrolyte-electrode assembly through an external electric circuit operably connected to terminals of the discharge unit to produce electric power in the external electric circuit and to generate one or more forms of the discharge fluid on consumption of the neutral oxidant fluid and one or more forms of the reducer fluid.

Also, disclosed herein is a discharge system comprising a neutral oxidant fluid comprising one or more forms of an aqueous multi-electron oxidant (AMO), one or more forms of a reducer fluid comprising one or more forms of a reducer, and the discharge unit. The discharge unit comprises an electrolytic cell stack. The electrolytic cell stack comprises multiple electrolytic cells. Each electrolytic cell comprises an electrolyte-electrode assembly.

Also, disclosed herein is a method for producing electric power and regenerating an aqueous multi-electron oxidant (AMO) and a reducer in an energy storage cycle. The method provides the discharge system comprising one or more forms of the reducer fluid, a neutral oxidant fluid comprising one or more forms of the AMO, and the discharge unit. The method disclosed herein facilitates discharge in the discharge unit for producing electric power from the neutral oxidant fluid comprising one or more forms of the AMO, and from the reducer fluid comprising one or more forms of the reducer as disclosed above. A regeneration system regenerates one or more forms of the oxidant fluid comprising one or more forms of the AMO and the reducer fluid comprising one or more forms of the reducer in stoichiometric amounts from one or more forms of the discharge fluid using external power. A splitting-disproportionation (SD) reactor of the regeneration system converts one or more forms of the discharge fluid into an alkaline discharge fluid by using an externally supplied base and/or a base produced at one or more negative electrodes of the SD reactor configured for a no-aqueous multi-electron oxidant-on-negative electrode approach or an aqueous multi-electron oxidant-on-negative electrode approach. The SD reactor splits the alkaline discharge fluid into a reducer and an intermediate oxidant. The splitting process releases a stoichiometric amount of the reducer and the base in the SD reactor. The SD reactor further converts the intermediate oxidant into one or more forms of the AMO in one or more forms of the oxidant fluid via disproportionation of the intermediate oxidant with the base. The splitting and disproportionation processes are continued in the SD reactor in a batch mode of operation, or a cyclic flow mode of operation, or a cascade flow mode of operation, or any combination thereof, until a desired degree of conversion of a discharge product of the AMO into one or more forms of the AMO in one or more forms of the oxidant fluid is achieved. The regenerated oxidant fluid in one or more forms comprising the AMO and the regenerated reducer fluid comprising the reducer are then supplied to the discharge system for facilitating discharge in the discharge unit.

Also, disclosed herein is an apparatus comprising endplates and/or bipolar plates for use in a fuel cell or in a flow battery. In an embodiment, the apparatus is an electrolytic cell stack of the discharge unit. In another embodiment, the apparatus is an electrolysis unit. The endplates and/or the bipolar plates comprise one or more flow fields, for example, flow fields with parallel channels, or one or more serpentine channels, or interdigitated channels, or multi-ladder flow fields, etc. The multi-ladder flow fields comprise long parallel channels connected by short channels in a perpendicular direction. The long parallel channels are deeper than the short channels. The long parallel channels are configured to supply one or more reactants and to remove one or more discharge products substantially uniformly across a large area of the endplates and/or the bipolar plates. The short channels are configured to facilitate high utilization of an aqueous multi-electron oxidant and a uniform current density simultaneously.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a system for producing electric power from an oxidant fluid and a reducer fluid and simultaneously generating a discharge fluid using a discharge system, and for regenerating an aqueous multi-electron oxidant and/or a reducer from the discharge fluid using a regeneration system.

FIG. 2 exemplarily illustrates mass flows in a single electrolytic cell of an electrolytic cell stack of a discharge unit during discharge using MXO₃ as an aqueous multi-electron oxidant and hydrogen as a reducer.

FIG. 3 exemplarily illustrates a first cycle of operation of a splitting-disproportionation flow cell during a regeneration process using electrolytic splitting and MXO₃ as an aqueous multi-electron oxidant.

FIG. 4 exemplarily illustrates a second cycle of operation of a splitting-disproportionation flow cell operating in a no-aqueous multi-electron oxidant-on-negative electrode approach using electrolytic splitting and MXO₃ as the aqueous multi-electron oxidant.

FIG. 5A illustrates a method for producing electric power from an oxidant fluid comprising one or more forms of an aqueous multi-electron oxidant and a reducer fluid comprising one or more forms of a reducer, and for simultaneously generating a discharge fluid.

FIG. 5B illustrates a method for producing electric power and regenerating an aqueous multi-electron oxidant and a reducer in an energy storage cycle.

FIG. 6 exemplarily illustrates a table showing compositions of different fluids and processes in an energy storage cycle.

FIG. 7 exemplarily illustrates a multi-ladder flow field comprising ladders and multiple steps per ladder.

FIG. 8 exemplarily illustrates a graphical representation of discharge curves obtained in different experimental cells with different aqueous multi-electron oxidants and hydrogen gas on the negative electrodes of the experimental cells.

FIG. 9 exemplarily illustrates a regeneration system operating in a cyclic flow mode of operation configured for a no-aqueous multi-electron oxidant-on-negative approach.

### DETAILED DESCRIPTION OF THE INVENTION

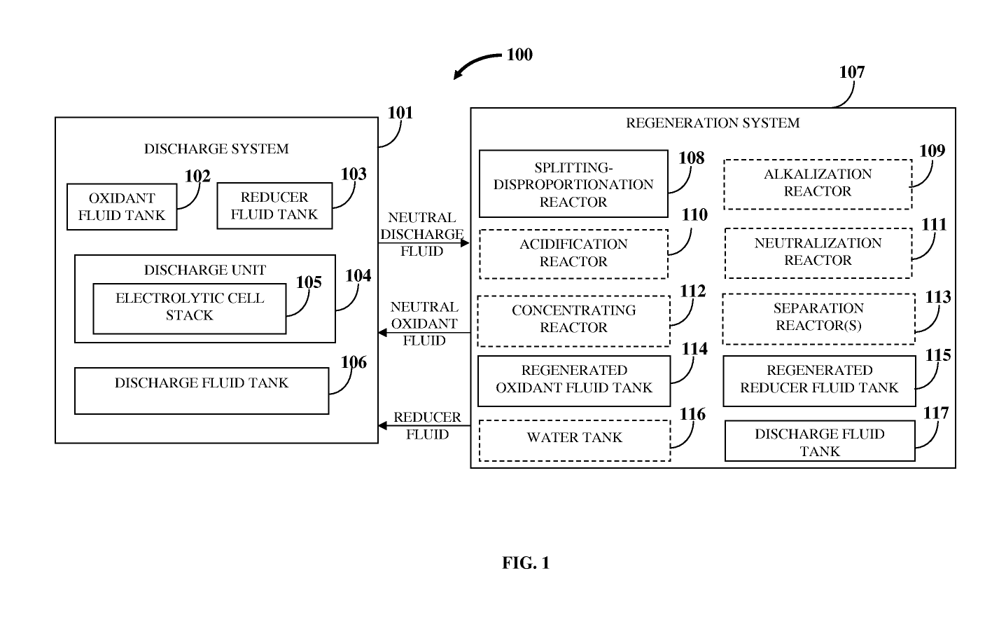

FIG. 1 illustrates a system 100 for producing electric power from an oxidant fluid and a reducer fluid and simultaneously generating a discharge fluid using a discharge system 101, and for regenerating an aqueous multi-electron oxidant (AMO) and/or a reducer from the discharge fluid using a regeneration system 107. The oxidant fluid is a chemical or a mixture of chemicals that accepts electrons during a discharge process in a discharge mode of operation of a discharge unit 104 of the discharge system 101. As used herein, “discharge mode of operation” refers to a process of releasing chemical energy stored in the discharge unit 104 in the form of sustainable electric current, for example, direct current (DC) and voltage. The oxidant fluid comprises water, one or more forms of an AMO, and one or more counter cations. The AMO may be present at various stages in the methods disclosed herein in one or several forms, for example, salt forms such as a lithium (Li) form, etc., differing in composition, concentration, etc. Aqueous multi-electron oxidant or AMO refers collectively to all such forms and any combination thereof. In an embodiment, one of the counter cations is lithium. In another embodiment, one of the counter cations is sodium. In another embodiment, one of the counter cations is magnesium. In another embodiment, one of the counter cations is calcium. In another embodiment, one of the counter cations is selected from the group comprising alkylammonium, arylammonium, imidazolium and its derivatives, pyridinium and its derivatives, choline and its derivatives, morpholinium and its derivatives, phosphonium and its derivatives, an organic cation, a cation capable of forming an ionic liquid, etc., and any combination thereof. The counter cations comprise, for example, hydronium ions, alkali metal cations, alkaline earth metal cations, rare earth cations, cations of aluminum, indium, gallium, and thallium, organic cations, and other cations forming a hydroxide with a logarithmic constant pKa between 5 and 12. The AMO comprises one or more of halogens, halogen oxides, halogen oxoanions, and salts, acids and other derivatives of halogen oxoanions and of halogen oxides. The halogen oxoanions comprise one or more of hypochlorite, chlorite, perchlorate, hypobromite, bromite, perbromate, hypoiodite, iodite, iodate, and periodate. In an embodiment, one of the halogen oxoanions is bromate. In another embodiment, one of the halogen oxoanions is chlorate. In another embodiment, the halogen oxoanions comprise a mixture of bromate and chlorate.

The oxidant fluid, for example, the neutral oxidant fluid, further optionally comprises one or more forms of one or more extra acids. The extra acids comprise, for example, an alkylsulfonic acid, an arylsulfonic acid, 3-(N-morpholino)propanesulfonic acid, 3-(N-morpholino)butanesulfonic acid, one or more of Good's buffers in an acid form, sulfuric acid, perchloric acid, triflic acid, nitric acid, and other strong acids. Good's buffers comprise about twenty buffering agents for biochemical and biological research selected and described by Norman Good and others. The oxidant fluid, or the discharge fluid, or a combination thereof further optionally comprises one or more forms of one or more buffers. The buffers comprise, for example, phosphoric acid, a derivative of phosphoric acid, a derivative of phosphonic acid, one or more of Good's buffers and derivatives of Good's buffers, a molecule comprising one or more sulfonic moieties and one or more phosphonic moieties, a molecule comprising one or more sulfonic moieties and one or more amine moieties, a (N-morpholino)alkanesulfonic acid, amino tris(methylene-phosphonic acid), a sulfoalkyl phosphonic acid such as 3-sulfopropyl phosphonic acid, a sulfoaryl phosphonic acid, and other molecules comprising in at least one form, a negatively charged group, and molecules capable of buffering pH in a range suitable for disproportionation. Disproportionation is a redox reaction in which an element, free or in a compound, is reduced and oxidized in the same reaction to form different products. For example, an element with an oxidation state A, not necessarily A=0, on disproportionation, is distributed between several species with different oxidation states B, C, etc., which differ from the element's initial oxidation state A, so that B>A>C. In an embodiment, the same molecular entity can serve as an extra acid and/or as a buffer, depending on the solution pH. 3-(N-morpholino)propanesulfonic acid also referred to as MOPS, is one example of such a bi-functional molecular entity. The reducer fluid comprises a reducer also referred herein as a “fuel”. The reducer is a chemical that donates electrons during the discharge process. The reducer fluid is, for example, hydrogen gas. The discharge fluid is an exhaust fluid obtained as a result of an electrochemical discharge process. The discharge fluid comprises one or more of water, a halide, and one or more counter cations. The discharge fluid further optionally comprises one or more forms of one or more buffers. In an embodiment, the discharge fluid further comprises an extra acid. In another embodiment, the discharge fluid further comprises a counter anion of an extra acid.

The system 100 disclosed herein comprises the discharge system 101 and the regeneration system 107. The discharge system 101 disclosed herein comprises an oxidant fluid tank 102, a reducer fluid tank 103, a discharge fluid tank 106, and a discharge unit 104. The oxidant fluid tank 102 stores a neutral oxidant fluid comprising an aqueous multi-electron oxidant (AMO), for example, 50% w aqueous LiBrO₃. As used herein, the term “neutral” encompasses near neutral. The AMO is a chemical that accepts electrons from an electrode during the electrochemical discharge process and acts as an oxidizing agent. The neutral oxidant fluid is stored in the discharge system 101, for example, on board a vehicle, and is used without prior on-board acidification. The concentration of acidic protons in the oxidant fluid is sufficiently low to prevent the decomposition of the AMO in a relevant time scale. For example, in the case of passenger electric vehicles, the relevant time scale is one week and the concentration of acidic protons is ≦1M or ≦0.1M. The reducer fluid tank 103 stores a reducer fluid comprising one or more forms of a reducer, for example, hydrogen (H₂). The reducer is a chemical that donates electrons to an electrode during the electrochemical discharge process and acts as a reducing agent. The discharge fluid tank 106 collects and stores the discharge fluid.

The discharge unit 104 disclosed herein is also referred to as a “flow battery”. The discharge unit 104 of the discharge system 101 comprises an electrolytic cell stack 105. The electrolytic cell stack 105 comprises multiple electrolytic cells. Each electrolytic cell comprises, for example, a 5-layer electrolyte-electrode assembly. The 5-layer electrolyte-electrode assembly comprises a 3-layer electrolyte-electrode assembly flanked by two diffusion layers. The 3-layer electrolyte-electrode assembly comprises a positive electrode, a negative electrode, and an electrolyte interposed between the positive electrode and the negative electrode. The positive electrode and the negative electrode are herein collectively referred to as “electrodes”. The term “electrode” refers to an electronic conductor or a mixed electronic-ionic conductor, the surface of which is in contact with an ionically conducting medium. The electrolyte is, for example, a poly(perfluorosulfonic) acid membrane or another cation-conducting membrane. The 5-layer electrolyte-electrode assembly is flanked by a positive diffusion layer on the positive side and a negative diffusion layer on the negative side forming the 5-layer electrolyte-electrode assembly. The 5-layer electrolyte-electrode assembly is flanked on each side by a bipolar plate or an endplate. In an embodiment, the endplates and/or the bipolar plates, each comprises one or more flow fields, for example, flow fields with parallel channels, or one or more serpentine channels, or interdigitated channels, or multi-ladder flow fields, etc. The electrolytic cell stack 105 with the oxidant fluid tank 102, the reducer fluid tank 103, the discharge fluid tank 106, and connecting lines form the discharge system 101. In an embodiment, the discharge system 101 is configured to operate in an electric partial recharge mode of operation for facilitating regenerative breaking when the discharge system 101 powers an electric vehicle. During the electric partial recharge mode of operation, the reducer is produced on the negative electrode of the electrolyte-electrode assembly and an intermediate oxidant is produced on the positive electrode of the electrolyte-electrode assembly.

The regeneration system 107 disclosed herein is configured to regenerate the aqueous multi-electron oxidant (AMO) and the reducer from the discharge fluid produced by the discharge unit 104. The regeneration system 107 comprises, for example, a splitting-disproportionation (SD) reactor 108, storage tanks such as a regenerated oxidant fluid tank 114, a regenerated reducer fluid tank 115, a water tank 116, and a discharge fluid tank 117. The blocks shown in dashed lines in FIG. 1 represent optional components that may be added to the regeneration system 107. The discharge fluid tank 117 stores a neutral discharge fluid received from the discharge system 101. The SD reactor 108 converts one or more forms of the discharge fluid into one or more forms of the oxidant fluid, for example, an alkaline oxidant fluid and other forms of the oxidant fluid. As used herein, the term “alkaline” refers to a fluid being “completely or fully alkaline” or “partially alkaline”. In an embodiment, the SD reactor 108 is configured as an electrolysis-disproportionation (ED) reactor comprising sub-reactors such as an electrolysis unit or an electrolyzer and a disproportionation unit. In another embodiment, the SD reactor 108 is configured as an ED reactor which does not comprise spatially separable sub-reactors such as the electrolysis unit and the disproportionation unit. The ED reactor comprises a stack of ED flow cells configured similar to a conventional polymer electrolyte fuel cell (PEFC) bipolar stack such that one side of each inner bipolar plate serves as a current collector of a negative electrode and the other side serves as a current collector of a positive electrode. Several ED flow cells can be configured into an ED reactor and operated in one or more modes and approaches. In another embodiment, the SD reactor 108 is configured as a photolysis-disproportionation reactor or as a photoelectrolysis-disproportionation reactor (not shown).

In an embodiment, the electrolysis-disproportionation (ED) reactor is configured for an aqueous multi-electron oxidant (AMO)-on-negative electrode approach using a multilayer structure on a negative electrode side of the ED reactor. In the AMO-on-negative electrode approach, the negative electrode comprises a multilayer or a graded catalytic layer configured to prevent electroreduction of relevant forms of the AMO while allowing for a hydrogen evolution reaction and alkalization to proceed. The multilayer structure on the negative electrode side of the ED reactor comprising, for example, an outer cation-selective membrane minimizes the reduction of a regenerated AMO in a regenerated oxidant fluid on the negative electrode side while facilitating hydrogen evolution and an increase in pH of the regenerated oxidant fluid. In another embodiment, the ED reactor is configured for a no-AMO-on-negative electrode approach by transferring a base produced on one or more negative electrodes of the ED reactor to a regenerated oxidant fluid produced at one or more positive electrodes of the ED reactor and comprising the intermediate oxidant or the discharge product of the AMO. In the no-AMO-on-negative electrode approach, the base produced on the negative electrode is mixed with one or more forms of an oxidant fluid or a discharge fluid without bringing the AMO in contact with the negative electrode.

In an embodiment, the regeneration system 107 comprises an alkalization-neutralization reactor (not shown) which can be functionally combined with the splitting-disproportionation (SD) reactor 108. In another embodiment, the regeneration system 107 disclosed herein comprises a separate alkalization reactor 109 and a separate neutralization reactor 111 as exemplarily illustrated in FIG. 1. In an embodiment, the alkalization reactor 109 and the neutralization reactor 111 are functionally combined as an alkalization-neutralization reactor. The alkalization reactor 109 converts a neutral discharge fluid into an alkaline discharge fluid by using an externally supplied base and/or a base produced in the SD reactor 108. In an embodiment, the base can be added after the splitting process in the SD reactor 108. The neutralization reactor 111 converts one or more forms of the oxidant fluid into a neutral oxidant fluid, or an acidic oxidant fluid, or a combination thereof. As used herein, the term “acidic” refers to a fluid being “completely or fully acidic” or “partially acidic”. In an embodiment, the neutralization reactor 111 is a partial acidification reactor. In an embodiment, the regeneration system 107 further optionally comprises an acidification reactor 110. The acidification reactor 110 performs buffer protonation and partial acidification in the off-board regeneration system. The acidification reactor 110 and the neutralization reactor 111 are not required in the energy storage cycle, but the acidification reactor 110 and the neutralization reactor 111 can be optionally added in the regeneration system 107, for example, to increase the power and efficiency of the disclosed processes and/or of the disclosed reactors.

The regeneration system 107 disclosed herein further optionally comprises a concentrating reactor 112 and one or more separation reactors 113. The concentrating reactor 112 produces a concentrated solution of one or more forms of the oxidant fluid comprising one or more forms of the aqueous multi-electron oxidant (AMO), for example, a salt form or another form. One or more forms of the oxidant fluid comprise, for example, an acid form, a neutral form, an alkaline form, a partially acidic form, and a partially alkaline form. The salt form of the AMO is, for example, one of lithium bromate, lithium chlorate, calcium bromate, calcium chlorate, magnesium bromate, magnesium chlorate, halates such as chlorates and bromates of other alkali metals or cations, halates of other alkaline earth metals or cations, halates of rare earth metals or cations, halates of aluminum or aluminum group cations, halates of gallium, halates of indium, halates of thallium, halates of other cations with a suitable pKa of hydroxide between 5 and 12, halates of organic cations, other salts of halogen oxoanions, and any combination thereof. The separation reactors 113 are gas-liquid separators or separation reactors and are used to separate gases from liquids during the regeneration process. The storage tanks, for example, the regenerated oxidant fluid tank 114, the regenerated reducer fluid tank 115, the water tank 116, and a buffer tank (not shown) are used to store the regenerated neutral oxidant fluid, the regenerated reducer fluid, water, and the buffer respectively.

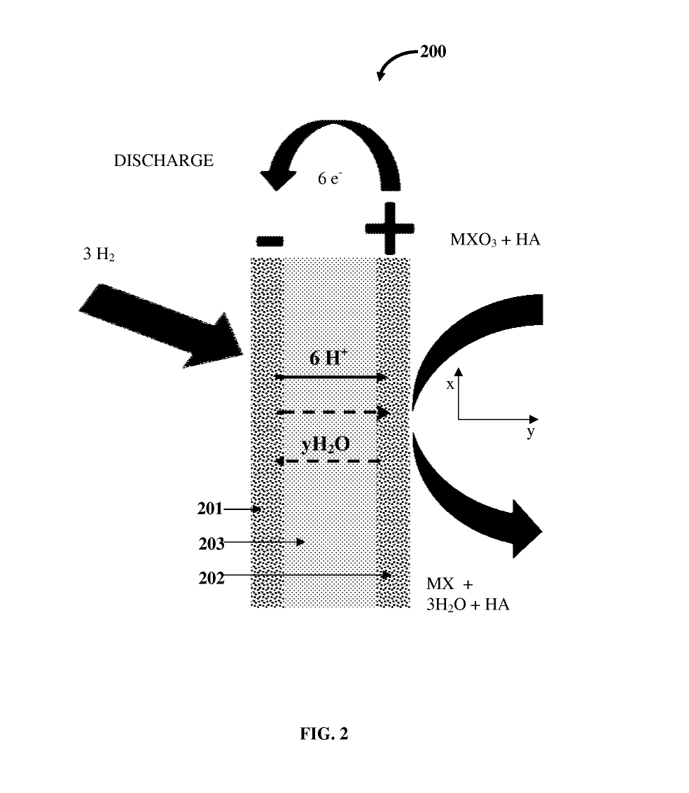

FIG. 2 exemplarily illustrates mass flows in a single electrolytic cell 200 of an electrolytic cell stack 105 of the discharge unit 104 exemplarily illustrated in FIG. 1, during discharge, using MXO₃, for example, LiBrO₃ as the aqueous multi-electron oxidant (AMO) and hydrogen (H₂) as the reducer. In the discharge system 101 exemplarily illustrated in FIG. 1, comprising a highly soluble AMO such as LiBrO₃ and a fuel such as H₂, acidification of an AMO stock is performed at the positive electrode 202 of the discharge cell or the electrolytic cell 200 using acidic protons generated at the negative electrode 201 and delivered through the electrolyte 203 to the positive electrode 202. In the exemplary case of bromate as the AMO and a non-electrocatalytic positive electrode 202, for example, an electrode made of a carbonaceous material, the acidic protons facilitate comproportionation of bromate with bromide yielding an actual electroactive intermediate, bromine. As used herein, the term “comproportionation” refers to a redox reaction in which an element, free or in compounds, with oxidation states A and C, is converted into another substance or substances in which the element's oxidation states are B, such that A>B>C. Bromine formed in reaction (1) below is produced in the vicinity of the positive electrode 202 or within a porous positive electrode 202, and not in the bulk of the oxidant fluid. The negative electrode 201 is referred herein as an “anode” and the positive electrode 202 is referred herein as a “cathode”.

Catholyte: BrO₃⁻+5Br⁻+6H⁺ [symbol] 3Br₂+6H₂O (1)

Cathode: 3Br₂+6e⁻ [symbol] 6Br (2)

Anode: 3H₂6e⁻ [symbol] 6H⁺ (3)

Total cathode: BrO₃⁻+6H⁺+6e⁻Br+3H₂Oe⁻/H⁺1 (4)

Although the disclosed discharge process exemplarily illustrated in reactions (1)-(4) above is illustrated with the example of bromate, a person of ordinary skill in the art can apply the disclosed discharge process exemplarily illustrated in reactions (1)-(4) above to chlorate, hypochlorite, and other aqueous multi-electron oxidants (AMOs).

Experiments were performed in a complete electrolytic cell 200 using 20%-50% w/w solutions of HBrO₃ as disclosed in the co-pending non-provisional patent application Ser. No. 13/969,597 titled “Flow Battery And Regeneration System”, and with a carbon rotating disk electrode in 5M MXO₃, for example, 5M LiBrO₃ solutions comprising, for example, sulfuric acid in about 30% concentration or phosphoric acid in about 50% concentration as disclosed in the co-pending continuation-in-part application Ser. No. 14/184,702 titled “Flow Battery And Regeneration System With Improved Safety”.

The ignition process exemplarily illustrated in reactions (1)-(3) above allows for an energy-efficient electroreduction of the aqueous multi-electron oxidant (AMO) on a non-catalytic electrode, for example, an electrode composed of inexpensive carbonaceous materials. For a glassy carbon rotating disk electrode, a normal ignition in AMO solutions is noted in the presence of low bulk acid concentrations in the oxidant fluid, and an abnormal ignition is noted in the presence of high bulk acid concentrations. In the case of the normal ignition observed at low bulk acid concentrations, the limiting current is controlled by a mass transport of acidic protons and the limiting current increases with stronger convection. In the case of the abnormal ignition observed at high bulk acid concentrations, the limiting current is determined by the rate of the homogeneous comproportionation reaction (1) near the electrode, and the limiting current shows an abnormal decrease at stronger convection. Unlike a rotating disk electrode, in the actual electrolytic cell 200, also referred herein as a “discharge flow cell” or a “discharge cell”, under certain conditions of design and operation, the addition of an acid to the AMO stock, that is, to the oxidant fluid that enters the discharge unit 104 is not required for the ignition regime to occur.

A high discharge current can be maintained by supplying acidic protons from a negative electrode 201 to a positive electrode 202 across an electrolyte 203, for example, a poly(perfluorosulfonic) acid membrane or another cation-conductive membrane, thereby eliminating the need for an acidification reactor 110 exemplarily illustrated in FIG. 1, such as an orthogonal ion migration across laminar flow (OIMALF) reactor in the on-board discharge system 101 or in the whole energy cycle. As used herein, “laminar flow” refers to a type of fluid flow in which directions and magnitudes of fluid velocity vectors in different points within a fluid do not change randomly in time and in space. Also, as used herein, the term “migration” refers to a movement of an electrically charged object such as an ion due to the action of an external electric field. Also, as used herein, the term “orthogonal” in “orthogonal ion migration across laminar flow” implies that the vectors of the laminar flow velocity and of the electric field are not parallel and not anti-parallel. The discharge of the aqueous multi-electron oxidant (AMO) is possible without external acidification, provided that a diffusion boundary layer on the positive electrode 202 has sufficient thickness. Such a condition can be observed when the pumping rate is slow enough. Slow flow rate reduces the losses of H⁺, of Br⁻, or of another halide, and of Br₂ or another halogen from the vicinity of the positive electrode 202 into the bulk of the discharge fluid or the oxidant fluid and facilitates comproportionation as exemplarily illustrated in reaction (1) below and electroreduction as exemplarily illustrated in reaction (2) below. The electroreduction on the positive electrode 202 is facilitated by comproportionation in the vicinity of or within the positive electrode 202 as exemplary illustrated in the case of bromate below:

BrO₃⁻+5Br⁻+6H⁺ [symbol] 3Br₂+6H₂O, (1)

3Br₂+6e⁻ [symbol] 6Br⁻ (2)

The comproportionation is further facilitated by a higher concentration of acids such as hydronium ions H₃O⁺. The high concentration of hydronium ions can be maintained in the vicinity of the positive electrode 202 or within the positive electrode 202 on discharge provided that the relevant rate constant of the loss of hydronium ions delivered across the electrolyte 203 to the positive electrode 202 into the bulk of the oxidant fluid is smaller than the relevant rate constant of the comproportionation in reaction (1) above. Such conditions are facilitated by a thick diffusion boundary layer, that is, at slow pumping rates at the positive electrode(s) 202 of the electrolytic cells of the electrolytic cell stack 105. The ignition regime is also facilitated by increasing the thickness of the porous positive electrode 202.

The aqueous multi-electron oxidant (AMO) does not need to be a single substance. Mixtures of two or more AMOs are also referred herein as AMO. An advantage of using mixtures of AMOs can be, for example, in separating and separately optimizing power density and energy density of the system 100 exemplarily illustrated in FIG. 1. For example, LiClO₃ has a higher molar solubility than LiBrO₃ but Br₂ intermediated affords a higher power or efficiency than a Cl₂ intermediate. Both power density and energy density of the energy producing discharge system 101 can be optimized when a mixture of, for example, LiBrO₃ and LiClO₃ is used as the AMO. The following reaction occurs in the vicinity or within the positive electrode 202 and is facilitated by acidic protons supplied across the electrolyte 203 from the negative electrode 201:

ClO₃⁻+6Br⁻+6H⁺=3Br₂+Cl⁻+3H₂O (5)

The redox cross-proportionation exemplarily illustrated in reaction (5) above allows for a charge transfer from high energy chlorate to high power bromine.

The discharge of the aqueous multi-electron oxidant (AMO) is possible without external acidification, provided that the pumping rate is slow enough. The TRIZ contradiction acknowledged and solved herein is that, even though slow pumping rates favor the ignition mode of reduction both with and without external acidification of the AMO stock or the oxidant fluid, the actual pumping rates and current may be too low to produce an acceptable power density or efficiency for automotive or stationary applications. At higher pumping rates and thus, a thinner diffusion boundary layer and a higher current, which are desirable for applications requiring a high power density, the ignition mode may disappear because the acidic protons transferred from the negative electrode 201 to the positive electrode 202 across the electrolyte 203 may escape the diffusion boundary layer in the vicinity of the positive electrode 202 into the bulk of the oxidant fluid and/or the discharge fluid before the acidic protons have a chance to participate in reaction (1) above in the vicinity of the positive electrode 202. At low pumping rates and/or with a thick porous positive electrode 202, the ignition mode of discharge can be observed with minimal acidification of the bulk oxidant fluid comprising the AMO or without an external acidification since acidic protons are supplied from the negative electrode 201 to the positive electrode 202 across the electrolyte 203, for example, a proton-conducting membrane. This TRIZ contradiction is solved by a proper configuration of the positive electrode flow field and the diffusion layer and/or the porous positive electrode 202 and an appropriate pumping rate of the oxidant fluid in neutral or partially acidic forms, so that the ignition regime of the discharge is maintained, the current density is high and sufficiently uniform, and a high utilization of the AMO is achieved. In practice, a proper configuration of an electrode comprises a porous electrode with, for example, about 0.02 mm to about 2 mm thickness, about 15% to about 85% porosity, and about 1 micron to about 200 micron characteristic pore size, that is, dimensions comparable with the kinetic layer thickness used for the comproportionation reaction.

Another TRIZ contradiction acknowledged and solved herein is membrane dehydration of the negative side due to an electro-osmotic water drag from the negative electrode 201 to the positive electrode 202. At high current densities produced in the electrolytic cell 200, the back diffusion of H₂O from the positive electrode 202 to the negative electrode 201 may not be sufficient to prevent dehydration on the negative side due to electro-osmosis and/or the electro-osmotic water drag. This contradiction is resolved by using a thin electrolyte membrane and/or by humidification of the fuel. Examples of a thin electrolyte membrane are Nafion® HP of E. I. du Pont de Nemours and Company with a thickness of about 20.3 μm, Nafion® XL available from Electrochem, Inc., with a thickness of about 25.7 μm, and Gore-Select® of W. L. Gore & Associates, Inc., with a thickness of about 20 μm.

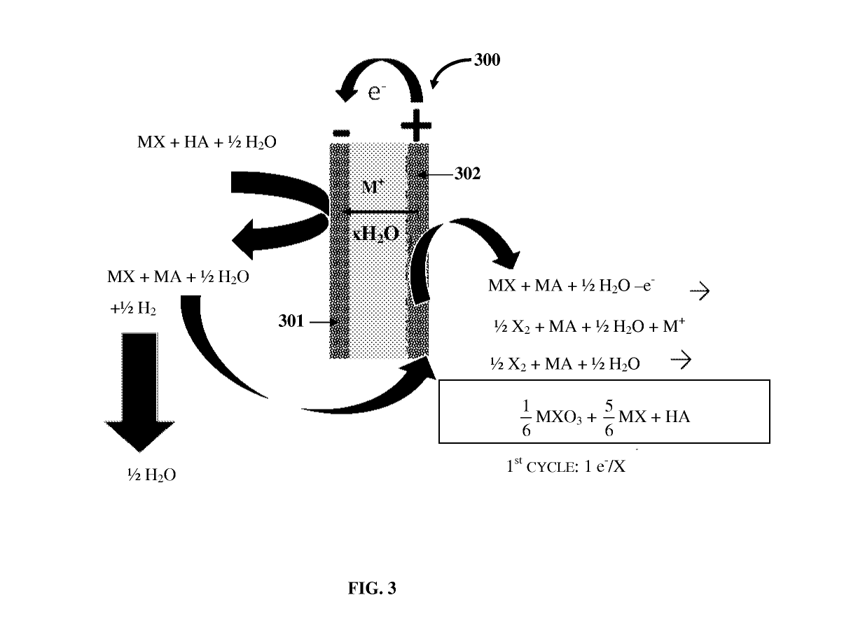

FIG. 3 exemplarily illustrates a first cycle of operation of a splitting-disproportionation (SD) flow cell 300 during a regeneration process using electrolytic splitting and MXO₃, for example, LiBrO₃ as an aqueous multi-electron oxidant (AMO). For purposes of illustration, the MXO₃ chemistry and the splitting of MX, for example, HBr or LiBr performed via electrolysis are exemplarily illustrated in FIG. 3. During the first run in the cycle, the discharge fluid comprising bromide and an acid form of a buffer HA goes through the negative electrode 301. Hydrogen evolution reaction (HER) and alkalization take place on the negative electrode 301. The acid form of the buffer HA is converted into a base form of the buffer LiA. The alkaline discharge fluid comprising LiA and LiBr goes to the positive electrode 302, wherein X₂, for example, Br₂, is generated and disproportionates in the presence of LiA. Overall, the alkaline discharge fluid is transferred from the negative electrode 301 to the positive electrode 302 and a halogen, for example, bromine evolution and disproportionation takes place near the positive electrode 302. In an embodiment, in the first regeneration cycle, the discharge fluid does not contain the AMO and can be alkalized at a Pt-containing negative electrode. In subsequent regeneration cycles, pumping of the AMO containing fluid through the negative electrode 301 may cause electroreduction of the AMO.

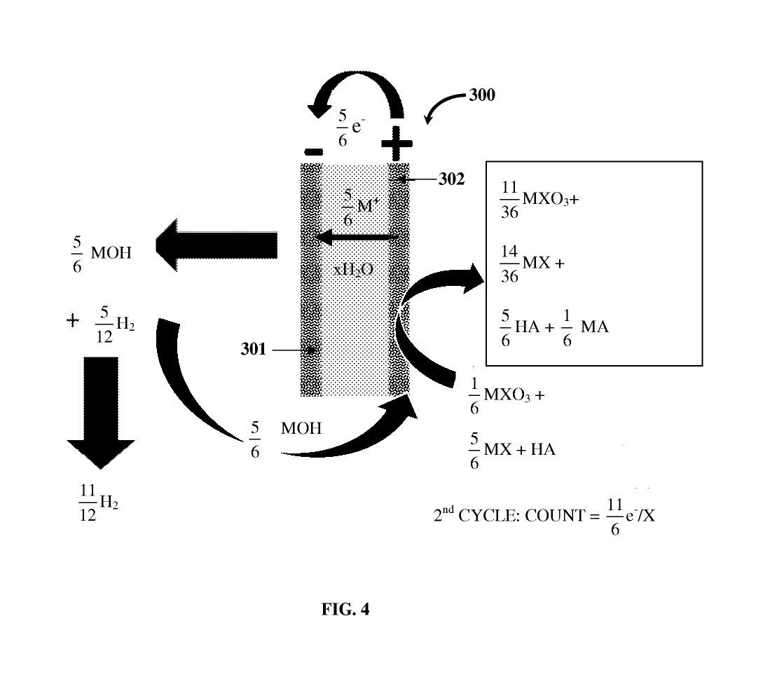

FIG. 4 exemplarily illustrates a second cycle of operation of a splitting-disproportionation (SD) flow cell 300, operating in a no-aqueous multi-electron oxidant (AMO)-on-negative electrode approach, using electrolytic splitting and MXO₃, for example, LiBrO₃ as the AMO. Partially regenerated fluid comprising the AMO, for example, bromate, a discharged oxidant such as bromide, and the buffer HA is cycled through the positive electrode 302 only. In every cycle, the base MOH, for example, LiOH produced at the negative electrode 301 is supplied to the positive electrode 302 to convert a neutral form or an acid form of the buffer, HA, into the base form of the buffer LiA which facilitates the disproportionation. The hydrogen evolution reaction (HER) and alkali, for example, LiOH generation take place on the negative electrode 301. Overall, the base is transferred from the negative electrode 301 to the positive electrode 302 and a halogen, for example, bromine evolution and disproportionation takes place at the positive electrode 302.

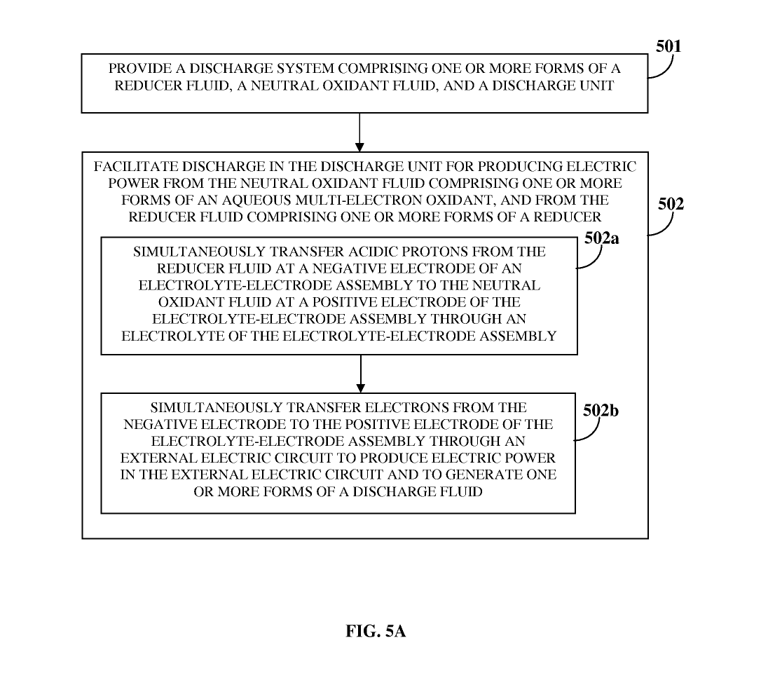

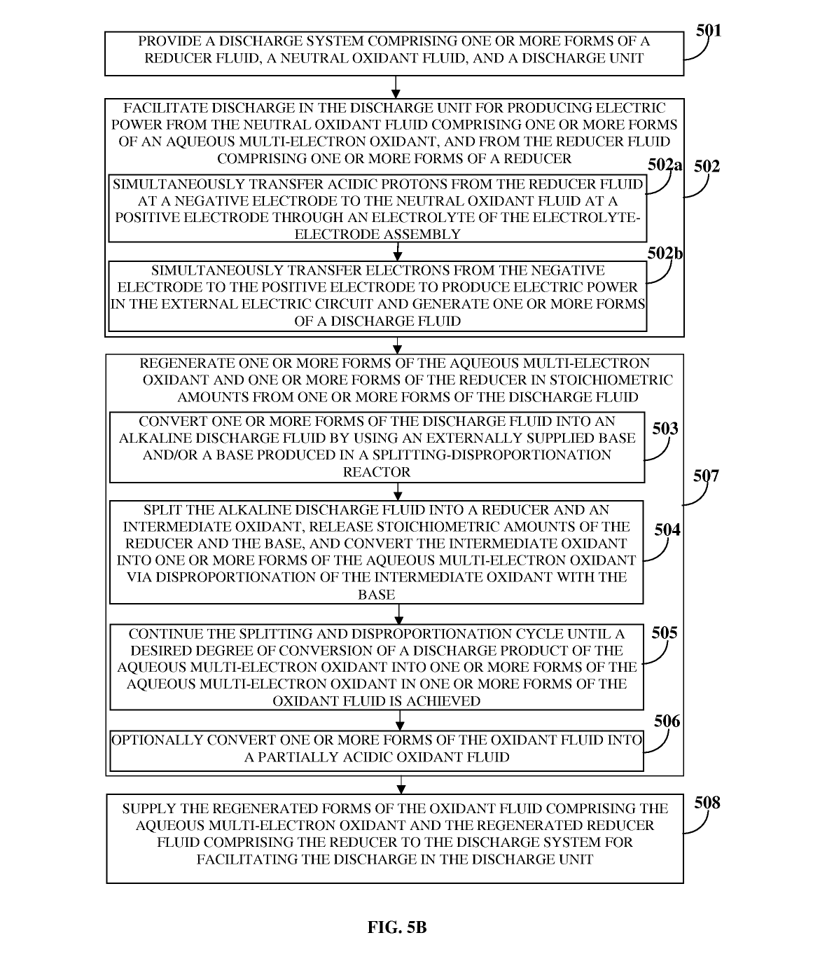

FIG. 5A illustrates a method for producing electric power from an oxidant fluid comprising one or more forms of an aqueous multi-electron oxidant (AMO) and a reducer fluid comprising one or more forms of a reducer, and for simultaneously generating a discharge fluid. In the method disclosed herein, the discharge system 101 comprising one or more forms of a reducer fluid, a neutral oxidant fluid, and the discharge unit 104 exemplarily illustrated in FIG. 1, is provided 501. The method disclosed herein further comprises maintaining stability of the neutral oxidant fluid by performing an ignition regime in the discharge system 101 under one or more of the following conditions: at low flow rates, with no acidification of the oxidant fluid stored in the oxidant fluid tank 102 of the discharge system 101 exemplarily illustrated in FIG. 1, and/or, for example, pH≧1 in the oxidant fluid stored in the oxidant fluid tank 102. In an embodiment, the stability of the neutral oxidant fluid is maintained by performing an ignition regime in the discharge system 101 at low acid concentrations and with no extra acid present in the neutral oxidant fluid. The total concentration of all forms of the AMO in one or more forms of the oxidant fluid stored in the discharge system 101 and/or supplied to the discharge unit 104 is, for example, above 1 M, or 2 M, or 5 M, or 10 M. The concentration of acidic protons in the neutral oxidant fluid stored in the oxidant fluid tank 102 and/or supplied to the discharge unit 104 is, for example, below 5 M, or 2 M, or 1 M, or 0.5 M, or 0.1 M, or 0.05 M, or 0.01 M, or 0.005 M.

In the method disclosed herein, discharge is facilitated 502 in the discharge unit 104 for producing electric power from the neutral oxidant fluid comprising one or more forms of the aqueous multi-electron oxidant (AMO), for example, lithium bromate and/or lithium chlorate, and from the reducer fluid comprising one or more forms of the reducer, for example, hydrogen. The facilitation of discharge comprises simultaneously transferring 502a acidic protons from the reducer fluid at a negative electrode of the electrolyte-electrode assembly to the neutral oxidant fluid at a positive electrode of the electrolyte-electrode assembly through an electrolyte of the electrode-electrolyte assembly, and simultaneously transferring 502b electrons from the negative electrode to the positive electrode of the electrolyte-electrode assembly through an external electric circuit operably connected to terminals of the discharge unit 104 to produce electric power in the external electric circuit and to generate one or more forms of the discharge fluid on consumption of the neutral oxidant fluid and one or more forms of the reducer fluid. In an embodiment, the concentration of the acidic protons in the discharge fluid is, for example, below 0.01 M, or 0.05 M, or 0.1 M.

In an embodiment, the transfer of the electrons from the negative electrode to the positive electrode of the electrolyte-electrode assembly through the external electric circuit is facilitated by a simultaneous transfer of acidic protons, for example, in the form of hydronium ions across the electrolyte from the negative electrode to the positive electrode. The transfer of the electrons from the negative electrode to the positive electrode of the electrolyte-electrode assembly through the external electric circuit is performed at a high current density and at low flow rates at the positive electrode via an ignition mode of operation of the discharge system 101. The discharge is facilitated at low flow rates via an ignition mode of operation of the discharge system 101.

The discharge is facilitated on the positive electrode of the electrolyte-electrode assembly, for example, by one or more of electrocatalysis, a solution-phase chemical reaction, a solution-phase comproportionation, a solution-phase redox catalysis, a solution-phase redox mediator, an acid-base catalysis, and any combination thereof. In an embodiment, the discharge is facilitated via a solution-phase comproportionation of the aqueous multi-electron oxidant (AMO) with a final product of a reduction of the AMO. In an embodiment, the solution-phase comproportionation is pH-dependent and the discharge is facilitated in the presence of acidic protons from an acid. In an embodiment, the acidic protons are produced on the negative electrode and transferred to the positive electrode across the electrolyte. In an embodiment, the acid is supplied with the oxidant fluid to the positive electrode. The acid is, for example, a hydronium cation and derivatives of the hydronium cation. In another embodiment, the method disclosed herein further comprises regenerating a certain amount of an intermediate oxidant and the reducer in the discharge unit 104 from one or more forms of the discharge fluid by applying an electric current of a polarity opposite to a polarity of electric current through the discharge unit 104 during the discharge.

FIG. 5B illustrates a method for producing electric power and, for some reducers, regenerating an aqueous multi-electron oxidant (AMO) and a reducer in an energy storage cycle. In the method disclosed herein, the discharge system 101 comprising one or more forms of a reducer fluid, a neutral oxidant fluid, and the discharge unit 104 exemplarily illustrated in FIG. 1, is provided 501. The total concentration of all forms of the AMO in one or more forms of the oxidant fluid supplied to the discharge unit 104 of the discharge system 101 is, for example, above 1 M, or 2 M, or 5 M, or 10 M. In the method disclosed herein, discharge is facilitated 502 in the discharge unit 104 for producing electric power from the neutral oxidant fluid comprising one or more forms of the AMO, and from the reducer fluid comprising one or more forms of the reducer. The reducer comprises, for example, one or more of hydrogen, ammonia, hydrazine, hydroxylamine, phosphine, methane, a hydrocarbon, an alcohol, an aldehyde, a carbohydrate, a hydride, an oxide, a sulfide, an organic compound, an inorganic compound, and any combination thereof, with each other, or with hydrogen, or with water, or with another solvent. In an embodiment, the oxidant fluid stored in the oxidant fluid tank 102 of the discharge system 101 exemplarily illustrated in FIG. 1, and supplied to the discharge unit 104 is a neutral oxidant fluid. In an embodiment, the oxidant fluid stored in the oxidant fluid tank 102 of the discharge system 101 and supplied to the discharge unit 104 is a partially acidic oxidant fluid. The discharge unit 104 facilitates discharge by simultaneously transferring 502a acidic protons from the reducer fluid at a negative electrode of the electrolyte-electrode assembly to the neutral oxidant fluid at a positive electrode of the electrolyte-electrode assembly through an electrolyte of the electrode-electrolyte assembly, and simultaneously transferring 502b electrons from the negative electrode to the positive electrode of the electrolyte-electrode assembly through an external electric circuit operably connected to terminals of the discharge unit 104 to produce the electric power in the external electric circuit and to generate one or more forms of the discharge fluid on consumption of the neutral oxidant fluid and one or more forms of the reducer fluid. In an embodiment, the generated discharge fluid is a neutral discharge fluid. The discharge fluid is then collected in the discharge fluid tank 106 exemplarily illustrated in FIG. 1, for subsequent regeneration.

One or more forms of the oxidant fluid comprising one or more forms of the aqueous multi-electron oxidant (AMO) and the reducer fluid comprising one or more forms of the reducer are regenerated 507 in stoichiometric amounts from one or more forms of the discharge fluid in the regeneration system 107 exemplarily illustrated in FIG. 1, using external power. One or more forms of the discharge fluid comprise, for example, one or more of water, a halide, and one or more counter cations. In an embodiment, the discharge fluid further optionally comprises one or more forms of a buffer. During the regeneration of the AMO and the reducer, one or more forms of the discharge fluid are converted 503 into an alkaline discharge fluid in the splitting-disproportionation (SD) reactor 108 exemplarily illustrated in FIG. 1, or in another reactor using a base, for example, an externally supplied base or a base generated at one or more negative electrodes of the SD reactor 108 such as a base co-produced in the SD reactor 108 during hydrogen evolution. For example, the neutral discharge fluid leaving the discharge unit 104 exemplarily illustrated in FIG. 1, is converted into an alkaline discharge fluid in the SD reactor 108 or in another reactor. The SD reactor 108 is configured for a no-AMO-on-negative electrode approach or an AMO-on-negative electrode approach as disclosed in the detailed description of FIG. 1.

In an embodiment, the SD reactor 108 converts an externally supplied neutral discharge fluid into an alkaline discharge fluid using a base produced at the negative electrode of the SD reactor 108. The alkaline discharge fluid comprises the base form of the buffer. In an embodiment, the alkaline discharge fluid is oxidized at the positive electrode or the positive electrodes of the SD reactor 108 to produce an intermediate oxidant. In another embodiment, the intermediate oxidant disproportionates with the base form of the buffer present in the alkaline discharge fluid to produce one or more forms of the AMO. The SD reactor 108 or a separate alkalization reactor 109 exemplarily illustrated in FIG. 1, converts one or more forms of the discharge fluid, for example, a neutral discharge fluid comprising LiBr and HA, wherein HA is the acid form of a buffer, into one or more forms of the oxidant fluid, for example, a neutral oxidant fluid comprising LiBrO₃ and HA. In an embodiment, HA is water and MA is a hydroxide. For example, MA can be a metal hydroxide with a low solubility that provides an appropriate pH range for the disproportionation of a halogen. In embodiments where the alkaline form of the buffer MA is Ca(OH)₂ or Mg(OH)₂, or La(OH)₃, or Y(OH)₃, or Sc(OH)₃, or another alkaline earth hydroxide, or another rare earth hydroxide, or a well soluble or a poorly soluble salt or a hydroxide of lithium, of sodium, of magnesium, of calcium, of other alkalis, of other alkaline earth metals, of rare earth metals, of aluminum, of indium, of gallium, of thallium, and combinations thereof, these bases are found to be useful for flow batteries and for energy storage cycles, since in addition to facilitating the disproportionation, these bases result in high solubility of halates and halides, thereby providing a high energy density and a high specific energy for the AMO-flow battery systems where these cations are employed.

The pH of the alkaline discharge fluid is optimized and stabilized in the splitting-disproportionation (SD) reactor 108 using the buffer present in or added to one or more forms of the discharge fluid, a partially regenerated fluid, and the oxidant fluid to facilitate the disproportionation of the intermediate oxidant into one or more forms of the aqueous multi-electron oxidant (AMO). The pH of the alkaline discharge fluid is configured and/or adjusted to facilitate the disproportionation, for example, between 4 and 12 or between 6 and 10, or in another range suitable for the disproportionation of the specific intermediate oxidant. The buffer is configured to maintain the pH of the alkaline discharge fluid between 4 and 12 or between 6 and 10, or in another range suitable for the specific intermediate oxidant. The buffer is also configured to maintain a high solubility of one or more forms of the AMO and to minimize the oxidation of one or more components of the buffer by one or more forms of the AMO, by the intermediate oxidant, and on the positive electrodes of the SD reactor 108.

The base component of the buffer is selected from the group comprising, for example, a hydroxide ion, a poorly soluble solid hydroxide, an oxide or a hydroxide of an alkali, of an alkaline earth metal, for example, of Mg²⁺ and Ca²⁺, of a rare earth metal, of aluminum, of gallium, of indium, of thallium, of another cation with a suitable solubility product of hydroxide providing buffering capacity in the range of, for example, 6≦pH≦9 or 5≦pH≦12, a monohydrogen phosphate, a dihydrogen phosphate, a phosphate, a phosphate ester, a substituted phosphonate, alkylphosphonate, arylphosphonate, a deprotonated form of one or more of Good's buffers, an amine, a nitrogen heterocycle, another heterocycle or another heterocyclic compound, a molecule comprising one or more a phosphonic group, an amino group, a tertiary amino group, a secondary amino group, and a primary amino group, other acid-base groups with a logarithmic constant pKa between 6 and 9 or 5 and 12, and any combination thereof. The molecule further optionally comprises a sulfonic group. In an embodiment, the cationic component of the buffer comprises a cation of lithium. In another embodiment, the cationic component of the buffer comprises a cation of sodium. In an embodiment, the cationic component of the buffer comprises one or more cations of one or more of an alkali metal, of an alkaline earth metal, for example, of Mg²⁺ and Ca²⁺, of a rare earth metal, of aluminum, of gallium, of indium, of thallium, of another cation with a hydroxide buffering capacity in the pH range, for example, between 5 and 12. In an embodiment, the anionic component of the buffer comprises one or more of a substituted and/or isomeric (N-morpholino)alkanesulfonate, 2-(N-morpholino)ethanesulfonate, 3-(N-morpholino)propanesulfonate, 4-(N-morpholino)butanesulfonate, a sulfoalkyl phosphonate, a sulfoaryl phosphonate, and one or more forms and derivatives of amino tris(methylenephosphonate). In another embodiment, the anionic component of the buffer comprises one or more of a substituted and/or isomeric (N-morpholino)alkanesulfonate, 2-(N-morpholino)ethanesulfonate, 3-(N-morpholino)propanesulfonate, 4-(N-morpholino)butanesulfonate, one or more forms and derivatives of amino tris(methylenephosphonate), a sulfoalkylphosphonate, and a sulfoarylphosphonate, wherein a cationic component of the buffer is lithium. In another embodiment, the anionic component of the buffer comprises one or more of an alkylphosphonate and an arylphosphonate. In another embodiment, the anionic component of the buffer comprises one or more of an alkylphosphonate and an arylphosphonate, wherein a cationic component of the buffer is lithium, or sodium, or a combination thereof. In another embodiment, the base component of the buffer is monohydrogen phosphate and the cationic component of the buffer is sodium. In another embodiment, the anionic component of the buffer comprises a phosphonic moiety and the anionic component of the buffer is amino tris(methylenephosphonate) and 3-sulfopropylphosphonate, their isomers, homologues, derivatives, etc. In another embodiment, the buffer in one of its forms is one or more of a dihydrogen phosphate, another ω-(N-morpholino)alkanesulfonate, a substituted phosphonate, a molecule comprising sulfonic moieties and phosphonic acid moieties, an amine, a heterocyclic compound, a compound capable of buffering solution pH between 4 and 12 and between 6 and 10, etc.

The splitting disproportionation (SD) reactor 108 splits 504 the alkaline discharge fluid at the selected pH into a reducer and an intermediate oxidant. In an embodiment, the SD reactor 108 splits, for example, the neutral discharge fluid comprising, for example, Br⁻ and HA into a reducer such as H₂, a base such as A⁻, and an intermediate oxidant such as Br₂. The SD reactor 108 splits the alkaline, neutral or other form of the discharge fluid into the reducer and the intermediate oxidant, for example, via electrolysis, or photolysis, or photoelectrolysis, or radiolysis, or thermolysis, or any combination thereof. The processes of photolysis and photoelectrolysis of one or more forms of the discharge fluid are performed in the presence or absence of a light adsorbing facilitator, or a semiconductor, or a catalyst, or any combination thereof. In an embodiment, the SD reactor 108 is configured, for example, as a photolysis-disproportionation reactor or as a photoelectrolysis-disproportionation reactor. In the case of photolysis, the splitting process, for example, LiBr+HA=½ Br₂+½H₂+LiA is facilitated by visible or ultraviolet light. In the case of radiolysis, the splitting process is facilitated by ionizing radiation such as α-rays, β-rays, γ-rays, X-rays, electrons, neutrons, protons, etc. In the case of photoelectrolysis, the splitting is facilitated by a semiconductor in the form of a bulk photoelectrode or particles.

The splitting process releases 504 a stoichiometric amount of the reducer and of the base in the splitting disproportionation (SD) reactor 108. The SD reactor 108 further converts 504 the intermediate oxidant, for example, Br₂ into one or more forms of the aqueous multi-electron oxidant (AMO) such as BrO₃⁻ via disproportionation of the intermediate oxidant with the base. The disproportionation is facilitated at low flow rates in the regeneration system 107. An example of a disproportionation reaction is illustrated below:

3Br₂+6A⁻+3H₂O=5Br⁻+BrO₃⁻+6HA

The splitting disproportionation (SD) reactor 108 continues 505 the cycle of splitting-disproportionation, for example, in a batch mode of operation, or a cyclic flow mode of operation, or a cascade flow mode of operation, or any combination thereof, until a desired degree of conversion of a discharge product of the aqueous multi-electron oxidant (AMO) into one or more forms of the AMO in one or more forms of the oxidant fluid is achieved. In an embodiment, the optional neutralization reactor 111 or, in another embodiment, the acidification reactor 110 of the regeneration system 107 optionally converts 506 one or more forms of oxidant fluid into a neutral oxidant fluid or into a partially acidic oxidant fluid, or into a combination thereof. The regenerated forms of the oxidant fluid, for example, the acidic oxidant fluid comprising the AMO and the regenerated reducer fluid comprising the reducer are supplied 508 to the discharge system 101 for facilitating the discharge in the discharge unit 104.

The compositions, that is, the predominant forms of the components of fluids relevant to the disclosed energy cycle illustrated by the example of LiBrO₃ as the aqueous multi-electron oxidant (AMO) and LiA as the buffer are provided in the table below:

| | Oxidant fluid | Discharge fluid |
|---|---|---|
| acidic | HBrO₃, HA | HBr, HA |
| neutral | LiBrO₃, HA | LiBr, HA |
| alkaline | LiBrO₃, LiA | LiBr, LiA |

In another example, the compositions, that is, the predominant forms of the components of fluids relevant to the disclosed energy cycle with a halate salt M(XOₙ)ₖ as the AMO and MAₖ as the buffer are shown in the table below:

| | Oxidant fluid | Discharge fluid |
|---|---|---|
| acidic | HXOₙ, HA | HA, HA |
| neutral | M(XOₙ)ₖ, HA | MAₖ, HA |
| alkaline | M(XOₙ)ₖ, MA | MAₖ, MA |

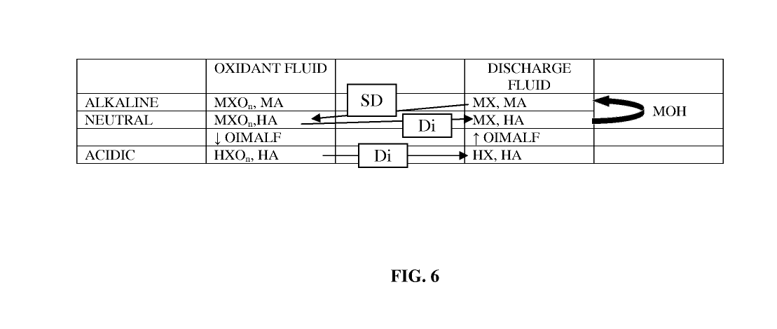

FIG. 6 exemplarily illustrates a table showing compositions of different fluids and processes in the energy storage cycle disclosed herein. The energy storage cycle is also referred herein as “energy and matter cycle”. As exemplarily illustrated in FIG. 6, “SD” denotes splitting-disproportionation and “Di” denotes discharge. MXOₙ chemistry with a monovalent M⁺ is shown as disclosed and exemplarily illustrated in FIG. 6, as a means of illustration and not a means of limitation. In FIG. 6, examples for X are Cl⁻, Br⁻, I⁻, etc.; examples for M are Li⁺, Na⁺, ½Mg⁺², ½Ca⁺², etc.; n=1, 2, 3, or 4; and examples for A are OH⁻, a Good's buffer, a phosphonate, etc.

### Example 1

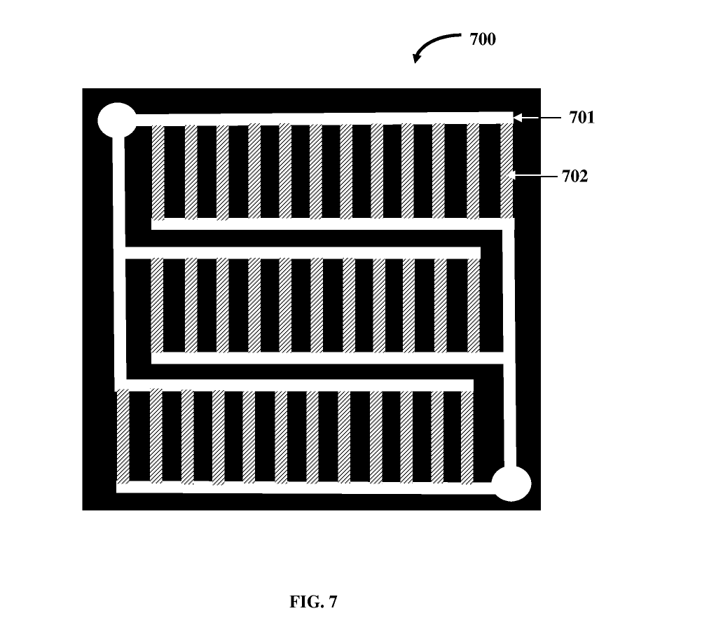

FIG. 7 exemplarily illustrates a multi-ladder flow field 700 comprising, for example, three ladders, and multiple steps, for example, eleven to twelve steps per ladder. Endplates and/or bipolar plates of an apparatus, for example, the electrolytic cell stack 105 of the discharge unit 104 exemplarily illustrated in FIG. 1, each comprise the multi-ladder flow field 700. The multi-ladder flow field 700 comprises long parallel channels 701 connected by short channels 702 in a perpendicular direction. In an embodiment, the long parallel channels 701 shown in white are deeper than the shaded short channels 702 shown in FIG. 7. The advantages of a multi-ladder flow field 700 compared to other flow field designs known in the art of fuel cells comprise a low overall pressure drop, low linear flow rates favoring the ignition regime, more uniform current distribution, and a higher utilization of the aqueous multi-electron oxidant (AMO). Multi-ladder flow fields 700, which have a low pressure drop, are not used in fuel cells due to the possibility of a channel blockage upon formation of a second phase such as a water droplet or a gas bubble. In the case of the AMO chemistry, the flow on the positive electrode is a single liquid phase flow and the blockage drawback does not arise. The function and the structure of the negative side of the H₂-aqueous multi-electron oxidant (AMO) discharge cell are in many ways similar to the equivalent part of a polymer electrolyte fuel cell (PEFC), although the optimization of cell performance, for example, power and humidification requirements requires taking into account some intrinsic differences. A consideration in designing the negative side of the discharge cell is the enhanced water back diffusion from the positive side due to the presence of liquid water in the oxidant fluid. Provided that the electrolyte membrane such as Nafion® XL of E. I. du Pont de Nemours and Company with a thickness of about 27.5 μm, Nafion® HP of E. I. du Pont de Nemours and Company with a thickness of about 20 μm, Gore-Select® of W. L. Gore & Associates, Inc., with a thickness of about ≦5 μm, etc., is sufficiently thin, the operation of the discharge cell with dry H₂ near ambient temperature or at elevated temperatures and in the dead end mode is possible. Each of these three operating conditions provides a substantial benefit for on-board use of the discharge system 101 exemplarily illustrated in FIG. 1, in electric vehicles due to system size reduction to a point where at the system level, the H₂-AMO discharge cell can outperform a proton exchange membrane fuel cell (PEMFC) system in terms of efficiency, specific power, and power density.

Due to a high current density, for example, about ≧0.4 A/cm² in the H₂-aqueous multi-electron oxidant (AMO) discharge cell, compared to the current density of a H₂-air PEMFC which is, for example, about ≦0.6 A/cm², and due to a lower diffusion coefficient of the AMO in the liquid phase compared to the diffusion coefficient of O₂ in the gas, further modifications on the positive electrode side, for example, flow fields are considered. Interdigitated flow fields and/or flow through porous electrodes are advantageous on the positive electrode side of a discharge cell, especially when the electrode thickness is two to five times larger than the comproportionation reaction layer thickness. Furthermore, the discharge flow battery, also referred to as the discharge unit 104, disclosed herein is operated at a high current density and relies on the solution-phase comproportionation reaction which makes it different from other flow batteries, for example, vanadium redox flow battery for which serpentine flow fields have been recommended.

The rate of comproportionation in reaction (1) disclosed in the detailed description of FIG. 2, decreases with decrease of the concentrations of acidic protons, of the aqueous multi-electron oxidant (AMO) such as bromate, and of the final product of reduction of the AMO such as bromide. In the discharge unit 104 disclosed herein, the concentration of protons and of bromide at the electrode surface decreases at higher flow rates due to the reduction of the diffusion layer thickness. Flow velocity profile with a low ∂vₓ/∂y, where v is the linear flow velocity rate at a point, x is the direction of the flow, and y is the direction normal to the electrode surface, is preferred for the ignition regime and for maintaining a high current density. This can be achieved for a pressure-driven flow with deeper channels and lower linear flow rates. However, channels substantially deeper than the ignition length cause a quick depletion of the AMO near the electrode in the beginning of the channel. This translates into a high current density in the beginning of the channel and a low current density further along the channel and into an incomplete AMO utilization. This problem can be alleviated by convective mixing in the y direction, for example, by introducing fins or other obstacles into the channel wall. Alternatively or simultaneously, a flow field with channels which are shallow comparable to the ignition length and short comparable to a depletion length afford at the same time high and uniform current density and AMO utilization. An example of a suitable AMO flow field 700, referred herein as “multi-ladder” is exemplarily illustrated in FIG. 7. The AMO flow field 700 comprises long and deep parallel channels 701 connected by short and shallow channels 702 in the perpendicular direction. The long parallel channels 701 are configured to supply one or more reactants and to remove one or more discharge products substantially uniformly across a large area of the endplates and/or the bipolar plates, while the short channels 702 are configured to facilitate high utilization of the AMO and a uniform current density simultaneously. A low pressure drop is another advantage of the multi-ladder flow field 700. The multi-ladder flow field 700 is useful for other flow batteries and fuel cells. In an embodiment, the endplates and/or the bipolar plates comprise one or more flow fields, for example, flow fields with parallel channels, with one or more serpentine channels, with interdigitated channels, etc.

### Example 2

This example describes the use of a phosphonate buffer for disproportionation: Phosphonic acids typically have a pK₁ near 2.5 and pK₂ near 8.0. Thus, the R—PO₃²⁻ can be a suitable alkaline form of the buffer to facilitate the disproportionation during the aqueous multi-electron oxidant (AMO) regeneration process. If Li⁺ is used as the counter cation, the limited solubility of lithium phosphonates should be taken into account. The lithium salts of H₆ amino tris(methylenephosphonic) (ATMP) acid can be used as bases for the disproportionation reaction. The acid itself has a solubility of about 2.04 molality (m) at 20° C. in water. The reactions of interest are as follows:

H₆ATMP+6LiOH═Li₆ATMP+6H₂O

2Li₆ATMP+3Br₂+3H₂O=2Li₃H₃ATMP+5LiBr+LiBrO₃

3.124 g or 0.1304 mol of LiOH was dissolved in 10 mL of 50% w solution of AP-5 from Zschimmer & Schwarz Chemie GmBH comprising 6.50 g or 0.0217 mol of H₆ATMP in a flask. 0.0326 mol of bromine of about 5.20 g, 1.67 mL was added. The bromine color disappeared upon shaking the flask. The presence of bromate and bromide in the colorless solution was confirmed with electrospray ionization (ESI)-mass spectrometry (MS) and with ion chromatography (IC). The chemical formula for amino tris(methylenephosphonic acid) with an aqueous solubility of 2.04 m at 20° C. is shown below:

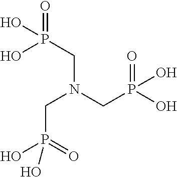 [SMILES: O=P(O)(O)CN(CP(=O)(O)O)CP(=O)(O)O]

### Example 3

This example describes the use of a sulfophosphonate buffer for disproportionation: The procedure for synthesis of 3-sulfopropyl phosphonic acid by addition of diethyphosphite to propanesultone followed by hydrolysis is described as follows: 1 mol of 1,3-propanesultone of about 122.14 g, mp 30-33° C. was placed in a sealed 500 mL round bottom flask equipped with a magnetic stir bar, and heated to 40° C. till it melts. 1 mol of diethylphosphite HPO(OEt)₂ of about 138.10 g, by 50-51° C./2 mmHg (lit.) was added drop wise over the course of 30 minutes. The reaction continued for another 2 hours. The product HO₃S—(CH₂)₃—PO(OEt)₂ was confirmed by electrospray ionization (ESI)-mass spectrometry (MS). The product was further treated with 2 moles of LiOH to produce LiO₃S—(CH₂)₃—PO(OEt)(OLi) along with the Li₂-salt. This compound buffers pH in the desired range, that is, a titration with HClO₄ produces pK₂≈8. In another experiment, HO₃S—(CH₂)₃—PO(OEt)₂ was treated with 3 moles of LiOH to produce LiO₃S—(CH₂)₃—PO(OLi)₂. After adding 1 mol of HBr, a solution comprising 1 mol of LiO₃S—(CH₂)₃—PO(OH)(OLi) and 1 mol of LiBr was produced. Both LiO₃S—(CH₂)₃—PO(OEt)(OLi) and LiO₃S—(CH₂)₃—PO(OH)(OLi) solutions were used for bromine disproportionation.

### Example 4

This example describes the discharge unit 104 exemplarily illustrated in FIG. 1, and the discharge process without a buffer. On the negative side, the electrolyte membrane is coated with a negative catalytic layer comprising, for example, Pt nanoparticles on carbon microparticles embedded into a Nafion® binder of E. I. du Pont de Nemours and Company. This negative catalytic layer is further bound to a negative diffusion layer comprising, for example, a porous carbon sheet. The negative catalytic layer and the negative diffusion layer are configured for a hydrogen oxidation reaction as known in the art.

The positive side of the electrolyte membrane is optionally coated with a positive catalytic layer comprising, for example, carbon microparticles or microfibers embedded into a Nafion® binder of E. I. du Pont de Nemours and Company. The carbon microparticles or microfibers may or may not carry Pt nanoparticles or other electrocatalysts. The positive side of the electrolyte membrane is positioned in contact with a positive diffusion layer comprising, for example, a sheet of hydrophilic porous carbon such as carbon hydrophilic cloth ELAT® of NuVant Systems, Inc. One or more 5-layer membrane-electrode assemblies (5 MEAs) stacked with bipolar plates are further flanked with endplates as known in the art of polymer electrolyte fuel cells. A fuel, for example, hydrogen is supplied to the negative endplate and delivered to the negative sides of the 5 MEAs. An oxidant fluid comprising, for example LiBrO₃ is supplied to the positive endplate and delivered to the positive sides of the 5 MEAs. Due to its high solubility, the concentration of LiBrO₃ in the oxidant fluid is, for example, between 5M and 8M or between 7 m and 14 m at 20° C., and higher at a higher temperature, for example, between 10 m and 26 m at 100° C. A discharge fluid comprising, for example, LiBr is produced on the positive sides of the 5 MEAs and exits through an outlet on the positive endplate. LiBr also has a high solubility, for example, 18.4 m at 20° C., which is higher than the solubility of LiBrO₃ at the same temperature.

In an embodiment, the oxidant fluid further optionally comprises an extra acid added to facilitate the electroreduction of the aqueous multi-electron oxidant (AMO), for example, bromate via comproportionation. As disclosed in the co-pending continuation-in-part application Ser. No. 14/184,702 titled “Flow Battery And Regeneration System With Improved Safety”, the concentration of the extra acid in the oxidant fluid determines the limiting current obtained on discharge in the case of normal ignition when protons are supplied to the positive electrode, only from the bulk of the oxidant fluid. The method and the system 100 exemplarily illustrated in FIG. 1, disclosed herein utilize, in the comproportionation reaction (1) disclosed in the detailed description of FIG. 2, acidic protons generated via the electrooxidation of the fuel, for example, H₂ on the negative electrode, and crossing over to the positive electrode. This allows for a decrease in the acid concentration in the oxidant fluid supplied to the discharge unit 104, for example, below 4M, 2M, 1M, 0.5M, 0.2M, 0.1M, or 0.05 M, or a complete elimination of the extra acid in the oxidant fluid supplied to the discharge unit 104 during the discharge operation. The decrease in the acid concentration in the oxidant fluid improves the stability of the oxidant fluid and the safety of the discharge system 101 exemplarily illustrated in FIG. 1, and of the overall energy cycle.

### Example 5

This example describes a discharge unit 104 exemplarily illustrated in FIG. 1, and a discharge process with a carried over buffer. Consider a 5-layer membrane-electrode assembly (5MEA) comprising a cation exchange membrane such as Nafion® 111 of E. I. du Pont de Nemours and Company or a thinner membrane. The process of regeneration of the aqueous multi-electron oxidant (AMO) or one or more forms of the oxidant fluid and the reducer fluid, that is, the fuel from one or more forms of the discharge fluid uses a cycle of electrolysis and disproportionation. A base form of a buffer, for example, 3-(N-morpholino)propanesulfonic acid (MOPS) is used to facilitate the disproportionation. In this case, one or more forms of the buffer are not separated from the AMO in the oxidant fluid but carried over to the discharge unit 104 as a component of the oxidant fluid. When the regeneration process disclosed in the co-pending continuation-in-part application Ser. No. 14/184,702 titled “Flow Battery And Regeneration System With Improved Safety” is followed, the neutral oxidant fluid comprising, for example, LiBrO₃ and H-MOPS leaves the splitting-disproportionation reactor 108 exemplarily illustrated in FIG. 1, configured as an electrolysis-disproportionation (ED) reactor. A complete neutralization of the buffer results in a neutral oxidant fluid which can be safely stored on board and used to produce power in the discharge unit 104 without additional acidification as disclosed herein.

A high power and/or a high efficiency can be achieved upon discharge if the oxidant fluid supplied to the discharge unit 104 is partially acidified. Such partial acidification does not need to be performed immediately prior to discharge and a partially acidic oxidant fluid can be safely stored on-board over a 1 week period without noticeable decomposition, if the concentration of acidic protons in the partially acidic oxidant fluid is, for example, below 4 M, or 2 M, or 1 M, or 0.5 M, or 0.2 M, or 0.1 M, or 0.05M. In an embodiment, the process of acidification of the neutral oxidant fluid can be performed by adding an external acid, which may not recycle all chemicals in the energy cycle.

Alternatively, for a partial off-board acidification, an orthogonal ion migration across laminar flow (OIMALF) process can be employed. In an embodiment, a neutral oxidant fluid exiting the electrolysis-disproportionation (ED) reactor and comprising, for example, LiBrO₃, H-MOPS, and H₂O is converted in an off-board OIMALF reactor into a partially acidic oxidant fluid comprising, for example, HBrO₃, LiBrO₃, H-MOPS, and H₂O. The partially acidic oxidant fluid can be safely stored on board of a vehicle; have a high charge and/or energy content, for example, 1000 Ah/L, which corresponds to approximately 6.2M or 56% w LiBrO₃ or more; and produce high power, for example, >0.5 W/cm² with the total concentration of the aqueous multi-electron oxidant (AMO), for example, bromate above 1 M, or 2 M, or 3 M, or 4 M, or 5 M, or 6 M, and with the concentration of acidic protons in the partially acidic oxidant fluid stored on board, for example, below 4 M, or 2 M, 1 M, 0.5 M, 0.2 M, 0.1 M, or 0.05 M.

During the discharge in the discharge unit 104, the neutral and/or monoprotonated form of the buffer, for example, H-MOPS is supplied along with the other components of the oxidant fluid, for example, LiBrO₃ to the positive electrode(s). Acidic protons such as H₂MOPS⁺, H₃O⁺, etc., may also be present if a partially acidic oxidant fluid is used. The presence of the acidic protons in the oxidant fluid supplied to the positive electrode(s) of the discharge unit 104 facilitates the discharge of the aqueous multi-electron oxidant (AMO) on the positive electrode(s). The buffer acidity ratio, that is, [H₃O⁺]/[HMOPS] is not affected by the discharge process if a stoichiometric number of protons is supplied to the positive electrode from the negative electrode, through the electrolyte membrane. Under such conditions, the buffer acidity ratios in the oxidant fluid entering the discharge unit 104 and in the discharge fluid leaving the discharge unit 104 are the same.

### Example 6

This example describes recovery of an oxidant from a degraded buffer. Over time, after many regeneration cycles, a buffer, for example, 3-(N-morpholino)propanesulfonic acid (MOPS) degrades. In such a case, the buffer decomposition products can be removed from the used discharge fluid comprising, for example, LiBr and H-MOPS, according to the following electrolysis-separation scheme using an electrolysis-disproportionation (ED) reactor or a specially configured reactor:

On the positive electrode configured for a halogen (X₂) evolution reaction, for example:

MX-e⁻=½X₂+M⁺ (6)

On the negative electrode:

H₂O+e⁻+M⁺=½H₂(gas)+MOH(dissolved or suspended in a liquid) (7)

where M⁺ moves from the positive electrode to the negative electrode across a cation-exchange membrane. In an embodiment, X is, for example, one or more of Cl, Br, I, and At, and M is one or more of alkali cations, alkaline earth cations, rare earth cations, cations of aluminum group metals, an organic cation, etc. The single positive charge (+) is shown for illustration, not for limitation. Multi-charged cations (M) can be employed, and in certain cases are preferred in reaction (7) disclosed above.

In the regeneration process, the recovery process entails a separation of the intermediate oxidant, for example, Br₂ or another halogen from the buffer and the products of its decomposition, for example, using distillation or extraction. The remaining liquid or solid comprising an acid form or another form of the buffer and its decomposition products is discarded, and the intermediate oxidant is collected for further preparation of the aqueous multi-electron oxidant (AMO). The preparation of the AMO entails the following reaction (8) between a fresh sample of the acid form of the buffer, for example, 3-morpholinopropanesulfonic acid (H-MOPS) available commercially, and a base such as LiOH produced in reaction (7) above followed by a disproportionation reaction (9) shown below:

LiOH+H-MOPS═Li-MOPS+H₂O (8)

½Br₂+Li-MOPS+½H₂O=⅙LiBrO₃+⅚LiBr+H-MOPS (9)

The partially regenerated neutral oxidant fluid produced in reaction (9) undergoes further cycles of electrolysis-disproportionation (7)-(9), for example, in the no-aqueous multi-electron oxidant (AMO)-on-negative electrode approach, until a desired degree of conversion of, for example, bromide into bromate is achieved. MOPS and Li are shown in example 6 as a means of illustration and not of limitation.

### Example 7

This example describes the use of lithium chlorate as the aqueous multi-electron oxidant (AMO). Lithium chlorate and chloride have higher molal solubilities than lithium bromate and lithium bromide. At 20° C., the solubility values are 19.696 m for LiCl and 41.15 m (78.86%) for LiClO₃, and at 60° C., the solubility values are 22.4 m and 85.96 m respectively, which makes this chemistry usable as the AMO in flow batteries. In particular, in a solid state, lithium chlorate and lithium bromate contain 1,779 ampere-hour per kilogram (Ah/kg) and 1,192 Ah/kg respectively, and in room temperature, saturated solutions 1,403 Ah/kg and 765 Ah/kg respectively. When combined with a 5% w hydrogen source of about 1,340 Ah/kg, the system level specific charges are 685 Ah/kg and 487 Ah/kg for LiClO₃ and LiBrO₃ systems respectively. Although, the solubility of LiCl does not match the solubility of LiClO₃, the formation of water in parallel with the formation of LiCl upon discharge compensates for this drawback, thus allowing the flow battery to work continuously without clogging.

Despite a 40% higher system level specific charge, LiClO₃ may not be preferred over LiBrO₃ in every application. One consideration is the slow rate of the chlorine/chloride electrode reaction and the cost of the dimensionally stable anode (DSA), for example, RuO₂—TiO₂ electrocatalyst, commonly used to facilitate the electrode reaction. In the discharge system 101 exemplarily illustrated in FIG. 1, the use of the Cl₂/2Cl⁻ electrode reaction can be avoided by using bromide as a mediator of chlorate reduction:

ClO₃⁻+6Br⁻+6H⁺=3H₂O+Cl⁻+3Br₂

3Br₂+6e⁻=+6Br⁻

Since bromide is recycled, bromide does not need to be present in a stoichiometric amount. During regeneration, the electrooxidation of chloride into chlorine using a dimensionally stable anode (DSA) may be acceptable in the automotive market since the capital cost can be efficiently amortized in a multiuser facility.

### Example 8

This example describes the use of elevated temperatures in the discharge system 101 exemplarily illustrated in FIG. 1. The solubility of the aqueous multi-electron oxidant (AMO) increases with increasing temperature. For lithium bromate, the ratio of molal solubilities between 60° C. and 0° C. is 1.75, and for lithium chlorate, the ratio of molal solubilities between 60° C. and 0° C. is 3.22. Hot AMO solutions can be used to further increase the specific energy of the discharge system 101 as well as the specific power due to higher rates of the chemical and electrode reactions involved. In an embodiment, heat generated by the discharge unit 104 exemplarily illustrated in FIG. 1, can be used to bring and maintain its temperature above ambient. The heat lost with the discharge fluid can be used to preheat the oxidant fluid in a heat exchanger. In an embodiment, all or some of the AMO can be present in an AMO container as a solid. The concentration of the AMO in the outgoing discharge fluid can be increased by warming the AMO, for example, with an external heat source or with the waste heat from the discharge fluid.

### Example 9

This example describes the discharge unit 104 exemplarily illustrated in FIG. 1, and the discharge process with or without a buffer. The 5-layer membrane-electrode assemblies (5MEAs) and the electrolytic cell stack 105 exemplarily illustrated in FIG. 1, are fabricated according to the following specifications: membranes-Nafion® XL of about 28 μm thickness, 7×7 cm² active area; positive electrodes: C+Nafion on a hydrophilic carbon cloth; negative electrodes: 1 mg Pt/cm² using 20 w/w % Pt/C catalyst on a hydrophobic carbon paper; parallel flow channel fields on both electrodes, anode and cathode flow channels are crossed and with two electrolytic cells in the electrolytic cell stack 105.

In an embodiment, the discharge unit 104 comprises two 7×7 cm² flow cell stacks or electrolytic cell stacks 105 with a Pt-free positive electrode, 50 cm² active area fuel cell hardware, parallel flow channels on both sides, and an FC50-membrane electrode assembly (MEA). The MEA membrane is, for example, Nafion® 111 of E. I. du Pont de Nemours and Company. The positive side electrode or the positive electrode is, for example, C+Nafion® on a hydrophilic carbon cloth. The negative side electrode or the negative electrode is, for example, 1 mg Pt/cm² using about 20 wt % of Pt/C catalyst on a hydrophobic carbon paper.

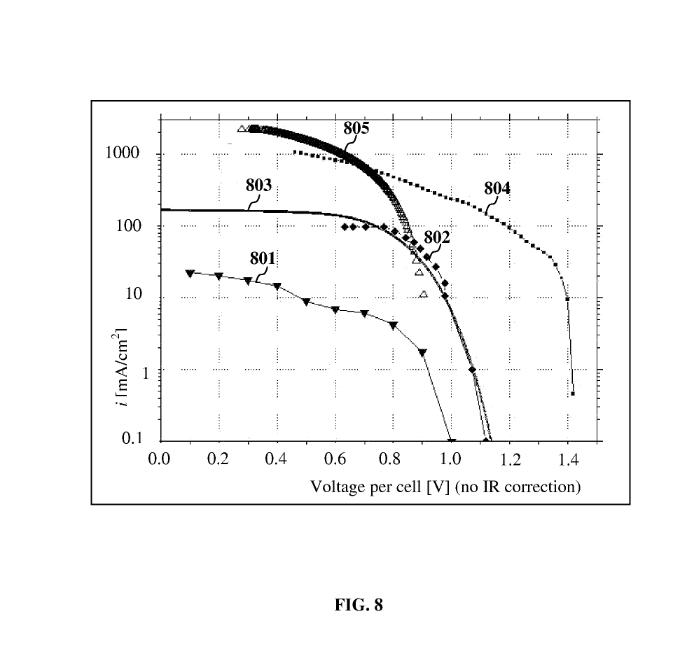

FIG. 8 exemplary illustrates a graphical representation of discharge curves obtained in different experimental cells with different aqueous multi-electron oxidants (AMOs) and hydrogen (H₂) gas on the negative electrodes or reference electrodes of the experimental cells. The discharge curves are explained below with the following specifications for a temperature of about 20° C.: Curve 801 exemplarily illustrates a discharge curve for a discharge of 50% aq. LiBrO₃ without acid on a carbon paper versus non-humidified H₂ on 1 mg/cm² 20% PtC separated by a Nafion® XL membrane of 27.5 micrometers thickness in an electrolytic cell stack of two cells, each with a 7×7 cm² electrode area. Curve 802 exemplarily illustrates a discharge curve for discharge of 50% LiBrO₃ with 2M methanesulfonic acid (SA) in the same electrolytic cell stack of two cells, each with a 7×7 cm² electrode area. Curve 803 exemplarily illustrates a discharge curve for discharge of 2M HBrO₃ with 1M H₂SO₄ on a 5 mm glassy carbon rotating disk electrode (RDE) at 30 rpm. Curve 804 exemplarily illustrates a discharge curve for discharge of 50% HBrO₃ in a 5*5 cm² cell with Pt gauzes on the positive electrode and the negative electrode. Curve 805 exemplarily illustrates a comparison of the discharge curve for a hydrogen (H₂)-air polymer electrolyte membrane (PEM) fuel cell and a no-aqueous multi-electron oxidant (AMO)-on-negative electrode based discharge fuel cell.

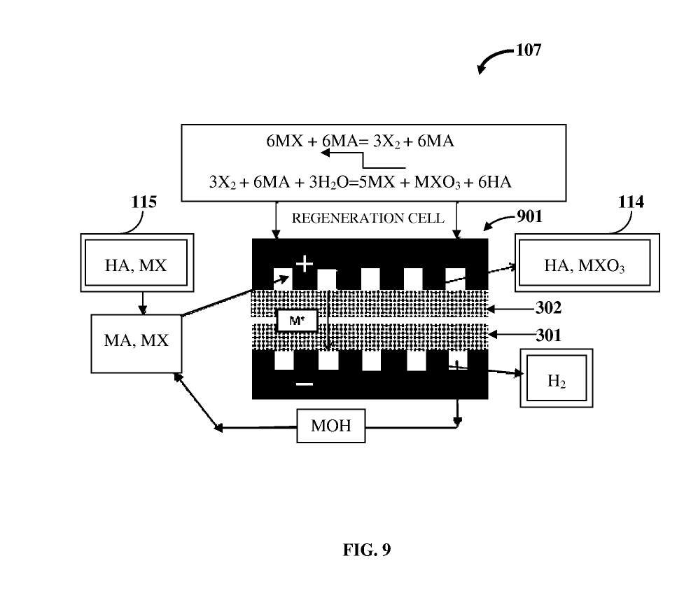

FIG. 9 exemplarily illustrates a regeneration system 107 operating in a cyclic flow mode of operation configured for a single cell electrolysis-disproportionation (ED) reactor 901 in the no-aqueous multi-electron oxidant (AMO)-on-negative electrode approach using electrolytic splitting. In an embodiment, the splitting-disproportionation (SD) reactor 108 of the regeneration system 107 exemplarily illustrated in FIG. 1, is configured as an electrolysis-disproportionation (ED) reactor 901. The ED reactor 901 splits or electrolyzes one or more forms of the discharge fluid into a reducer such as H₂, a base such as MOH, and an intermediate oxidant such as X₂ via electrolysis. The reducer is stored in the regenerated reducer fluid tank 115 and the intermediate oxidant is stored in the regenerated oxidant fluid tank 114. The process of electrolysis releases stoichiometric amounts of the reducer H₂ and the base such as a hydroxide, at a negative electrode 301 of the ED reactor 901. The base, for example, hydroxide further optionally reacts with a neutral form or an acidic form of the buffer HA to produce an alkaline form of the buffer. The buffer is present, for example, in the discharge fluid or in a partially regenerated fluid. The ED reactor 901 converts the intermediate oxidant X₂ produced at a positive electrode 302 of the ED reactor 901 into one or more forms of an AMO via disproportionation of the intermediate oxidant X₂ produced at the positive electrode 302 with the base produced at the negative electrode 301 or with the base form in the buffer present in the discharge fluid. An example of a disproportionation reaction is provided below:

3X₂+6MA+3H₂O=5MX+MXO₃+6HA

As exemplarily illustrated in FIG. 9, hydrogen (H₂) and a base MOH are produced on the negative electrode 301. The ED reactor 901 continues the electrolysis and disproportionation processes in the cyclic flow mode of operation, until a desired degree of conversion of a discharge product of the AMO into one or more forms of the AMO is achieved. In an embodiment, the ED reactor 901 continues the electrolysis and disproportionation processes in a batch mode of operation, or a cascade flow mode of operation, or a combination thereof, until a desired degree of conversion of a discharge product of the AMO into one or more forms of the AMO is achieved.

The foregoing examples have been provided merely for the purpose of explanation and are in no way to be construed as limiting of the method and the system 100 disclosed herein. While the method and the system 100 have been described with reference to various embodiments, it is understood that the words, which have been used herein, are words of description and illustration, rather than words of limitation. Further, although the method and the system 100 have been described herein with reference to particular means, materials, and embodiments, the method and the system 100 are not intended to be limited to the particulars disclosed herein; rather, the method and the system 100 disclosed herein extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the system 100 disclosed herein in their aspects.

I claim:

1. A method for producing electric power from an aqueous multi-electron oxidant and a reducer and for simultaneously generating a discharge fluid, said method comprising:
providing a discharge system comprising one or more forms of a reducer fluid, a neutral oxidant fluid, and a discharge unit, said discharge unit comprising an electrolytic cell stack, said electrolytic cell stack comprising a plurality of electrolytic cells, wherein each of said electrolytic cells comprises an electrolyte-electrode assembly; and
facilitating discharge in said discharge unit for producing said electric power from said neutral oxidant fluid comprising one or more forms of said aqueous multi-electron oxidant, and from said reducer fluid comprising one or more forms of said reducer, said facilitation of said discharge comprising:
simultaneously transferring acidic protons from said reducer fluid at a negative electrode of said electrolyte-electrode assembly to said neutral oxidant fluid at a positive electrode of said electrolyte-electrode assembly through an electrolyte of said electrode-electrolyte assembly; and
simultaneously transferring electrons from said negative electrode to said positive electrode of said electrolyte-electrode assembly through an external electric circuit operably connected to terminals of said discharge unit to produce said electric power in said external electric circuit and to generate one or more forms of said discharge fluid on consumption of said neutral oxidant fluid and said one or more forms of said reducer fluid.

2. The method of claim 1, wherein said aqueous multi-electron oxidant comprises one or more of halogens, halogen oxides, halogen oxoanions, and salts, acids and other derivatives of said halogen oxoanions and said halogen oxides.

3. The method of claim 2, wherein said halogen oxoanions comprise one or more of hypochlorite, chlorite, perchlorate, hypobromite, bromite, perbromate, hypoiodite, iodite, iodate, and periodate.

4. The method of claim 2, wherein said halogen oxoanions comprise one of bromate, chlorate, and a mixture of said bromate and said chlorate.

5. The method of claim 1, wherein said neutral oxidant fluid further comprises water and one or more counter cations.

6. The method of claim 5, wherein said one or more counter cations comprise hydronium ions, alkali metal cations, alkaline earth metal cations, rare earth cations, cations of aluminum, indium, gallium, and thallium, organic cations, and other cations forming a hydroxide with a pKa between 5 and 12.

7. The method of claim 5, wherein one of said one or more counter cations is lithium.

8. The method of claim 5, wherein one of said one or more counter cations is sodium.

9. The method of claim 5, wherein one of said one or more counter cations is calcium.

10. The method of claim 5, wherein one of said one or more counter cations is magnesium.

11. The method of claim 5, wherein said one or more counter cations comprise one or more of alkylammonium, arylammonium, imidazolium, derivatives of said imidazolium, pyridinium, derivatives of said pyridinium, choline, derivatives of said choline, morpholinium, derivatives of said morpholinium, phosphonium, derivatives of said phosphonium, an organic cation, a cation capable of forming an ionic liquid, and any combination thereof.

12. The method of claim 1, wherein said neutral oxidant fluid further optionally comprises one or more forms of one or more extra acids.

13. The method of claim 12, where said one or more extra acids comprise alkylsulfonic acid, arylsulfonic acid, 3-(N-morpholino)propanesulfonic acid, 3-(N-morpholino)butanesulfonic acid, one or more of Good's buffers in an acid form, sulfuric acid, perchloric acid, triflic acid, and nitric acid.

14. The method of claim 1, wherein one of said neutral oxidant fluid, said discharge fluid, and a combination thereof further optionally comprises one or more forms of one or more of a plurality of buffers.

15. The method of claim 14, wherein said buffers comprise phosphoric acid, a derivative of said phosphoric acid, a derivative of phosphonic acid, one or more of Good's buffers and derivatives of said Good's buffers, a molecule comprising one or more sulfonic moieties and one or more phosphonic moieties, a molecule comprising one or more sulfonic moieties and one or more amine moieties, a (N-morpholino)alkanesulfonic acid, amino tris(methylene-phosphonic acid), a sulfoalkyl phosphonic acid, a sulfoaryl phosphonic acid, and other molecules comprising a negatively charged group and molecules capable of buffering pH in a range suitable for disproportionation.

16. The method of claim 1, further comprising maintaining stability of said neutral oxidant fluid by performing an ignition regime in said discharge system at low flow rates and low acid concentrations, and with no extra acid present in said neutral oxidant fluid.

17. The method of claim 1, wherein a concentration of said aqueous multi-electron oxidant in said neutral oxidant fluid supplied to said discharge unit is above one of 1 M, 2M, 5M, and 10 M.

18. The method of claim 1, wherein a concentration of said acidic protons in said neutral oxidant fluid stored in said discharge system and supplied to said discharge unit is below one of 0.01 M, 0.05 M, 0.1 M, 0.5 M, 1 M, 2 M, and 5 M.

19. The method of claim 1, wherein said electrolyte is one of a poly(perfluorosulfonic) acid membrane and a cation-conducting membrane.

20. The method of claim 1, wherein said discharge fluid comprises one or more of water, a halide, one or more counter cations, an extra acid, a counter anion of an extra acid, and one or more forms of a buffer.

21. The method of claim 1, wherein said reducer is hydrogen.

22. The method of claim 1, wherein said discharge is facilitated on said positive electrode of said electrolyte-electrode assembly by one or more of electrocatalysis, a solution-phase chemical reaction, a solution-phase comproportionation, a solution-phase redox catalysis, a solution-phase redox mediator, an acid-base catalysis, and any combination thereof.

23. The method of claim 1, wherein said discharge is facilitated via a solution-phase comproportionation of said aqueous multi-electron oxidant with a final product of a reduction of said aqueous multi-electron oxidant.

24. The method of claim 23, wherein said solution-phase comproportionation is pH-dependent and said discharge is facilitated in a presence of said acidic protons.

25. The method of claim 1, further comprising regenerating a certain amount of an intermediate oxidant and said reducer in said discharge unit from said discharge fluid by applying an electric current of a polarity opposite to a polarity of electric current through said discharge unit during said discharge.

26. The method of claim 1, wherein a salt form of said aqueous multi-electron oxidant is one of lithium bromate, lithium chlorate, calcium bromate, calcium chlorate, magnesium bromate, magnesium chlorate, halates of other alkali metals, halates of other alkaline earth metals, halates of rare earth metals, halates of aluminum, halates of gallium, halates of indium, halates of thallium, halates of other cations with a pKa of hydroxide between 5 and 12, halates of organic cations, other salts of halogen oxoanions, and any combination thereof.

27. A discharge system comprising:
a neutral oxidant fluid comprising one or more forms of an aqueous multi-electron oxidant;
one or more forms of a reducer fluid comprising one or more forms of a reducer; and
a discharge unit comprising an electrolytic cell stack, said electrolytic cell stack comprising a plurality of electrolytic cells, wherein each of said electrolytic cells comprises an electrolyte-electrode assembly, said discharge unit configured to produce electric power from said neutral oxidant fluid and from said reducer fluid by:
simultaneously transferring acidic protons from said reducer fluid at a negative electrode of said electrolyte-electrode assembly to said neutral oxidant fluid at a positive electrode of said electrolyte-electrode assembly through an electrolyte of said electrode-electrolyte assembly; and
simultaneously transferring electrons from said negative electrode to said positive electrode of said electrolyte-electrode assembly through an external electric circuit operably connected to terminals of said discharge unit to produce said electric power in said external electric circuit and to generate one or more forms of said discharge fluid on consumption of said neutral oxidant fluid and said one or more forms of said reducer fluid.

28. The discharge system of claim 27 configured to operate in an electric partial recharge mode of operation, wherein said reducer is produced on said negative electrode of said electrolyte-electrode assembly and an intermediate oxidant is produced on said positive electrode of said electrolyte-electrode assembly during said electric partial recharge mode of operation.

29. The discharge system of claim 27, wherein said aqueous multi-electron oxidant comprises one or more of halogens, halogen oxides, halogen oxoanions, and salts, acids and other derivatives of said halogen oxoanions and said halogen oxides.

30. The discharge system of claim 27, wherein a salt form of said aqueous multi-electron oxidant is one of lithium bromate, lithium chlorate, calcium bromate, calcium chlorate, magnesium bromate, magnesium chlorate, halates of other alkali metals, halates of other alkaline earth metals, halates of rare earth metals, halates of aluminum, halates of gallium, halates of indium, halates of thallium, halates of other cations with a pKa of hydroxide between 5 and 12, halates of organic cations, other salts of halogen oxoanions, and any combination thereof.

31. An apparatus comprising one or more of endplates and bipolar plates, said one or more of said endplates and said bipolar plates comprising:
one or more multi-ladder flow fields comprising long parallel channels connected by short channels in a perpendicular direction, said long parallel channels configured to supply one or more reactants and to remove one or more discharge products substantially uniformly across a large area of said one or more of said endplates and said bipolar plates, said short channels are configured to facilitate high utilization of an aqueous multi-electron oxidant and a uniform current density simultaneously, wherein said long parallel channels are deeper than said short channels.

32. A method for producing electric power and regenerating an aqueous multi-electron oxidant and a reducer in an energy storage cycle, said method comprising:
providing a discharge system comprising one or more forms of a reducer fluid, a neutral oxidant fluid, and a discharge unit, said discharge unit comprising an electrolytic cell stack, said electrolytic cell stack comprising a plurality of electrolytic cells, wherein each of said electrolytic cells comprises an electrolyte-electrode assembly;
facilitating discharge in said discharge unit for producing said electric power from said neutral oxidant fluid comprising one or more forms of said aqueous multi-electron oxidant, and from said reducer fluid comprising one or more forms of said reducer, said facilitation of said discharge comprising:
simultaneously transferring acidic protons from said reducer fluid at a negative electrode of said electrolyte-electrode assembly to said neutral oxidant fluid at a positive electrode of said electrolyte-electrode assembly through an electrolyte of said electrode-electrolyte assembly; and
simultaneously transferring electrons from said negative electrode to said positive electrode of said electrolyte-electrode assembly through an external electric circuit operably connected to terminals of said discharge unit to produce said electric power in said external electric circuit and to generate one or more forms of said discharge fluid on consumption of said neutral oxidant fluid and said one or more forms of said reducer fluid;
regenerating one or more forms of an oxidant fluid comprising one or more forms of said aqueous multi-electron oxidant and said reducer fluid comprising one or more forms of said reducer in stoichiometric amounts from said one or more forms of said discharge fluid in a regeneration system using external power, said regeneration comprising:
converting said one or more forms of said discharge fluid into an alkaline discharge fluid by using one or more of an externally supplied base and a base produced at one or more negative electrodes of a splitting-disproportionation reactor configured for one of a no-aqueous multi-electron oxidant-on-negative electrode approach and an aqueous multi-electron oxidant-on-negative electrode approach;
splitting said alkaline discharge fluid into a reducer and an intermediate oxidant in said splitting-disproportionation reactor, wherein said splitting releases a stoichiometric amount of said reducer and said base in said splitting-disproportionation reactor;
converting said intermediate oxidant into one or more forms of said aqueous multi-electron oxidant in said splitting-disproportionation reactor via disproportionation of said intermediate oxidant with said base; and
continuing said splitting and said disproportionation in said splitting-disproportionation reactor in one of a batch mode of operation, a cyclic flow mode of operation, a cascade flow mode of operation, and any combination thereof, until a desired degree of conversion of a discharge product of said aqueous multi-electron oxidant into said one or more forms of said aqueous multi-electron oxidant in said one or more forms of said oxidant fluid is achieved; and
supplying said regenerated one or more forms of said oxidant fluid comprising said aqueous multi-electron oxidant and said regenerated reducer fluid comprising said reducer to said discharge system for said facilitation of said discharge in said discharge unit.

33. The method of claim 32, wherein said aqueous multi-electron oxidant comprises one or more of halogens, halogen oxides, halogen oxoanions, and salts, acids and other derivatives of said halogen oxoanions and said halogen oxides.

34. The method of claim 33, wherein said halogen oxoanions comprise one or more of hypochlorite, chlorite, perchlorate, hypobromite, bromite, perbromate, hypoiodite, iodite, iodate, and periodate.

35. The method of claim 33, wherein said halogen oxoanions comprise one of bromate, chlorate, and a mixture of said bromate and said chlorate.

36. The method of claim 32, wherein said oxidant fluid further comprises water, one or more counter cations, optionally one or more buffers, and optionally one or more extra acids.

37. The method of claim 36, wherein said one or more counter cations comprise hydronium ions, alkali metal cations, alkaline earth metal cations, rare earth cations, cations of aluminum, indium, gallium, and thallium, organic cations, and other cations forming a hydroxide with a pKa between 5 and 12.

38. The method of claim 36, wherein one of said one or more counter cations is lithium.

39. The method of claim 36, wherein one of said one or more counter cations is sodium.

40. The method of claim 36, wherein one of said one or more counter cations is calcium.

41. The method of claim 36, wherein one of said one or more counter cations is magnesium.

42. The method of claim 36, wherein said one or more counter cations comprise one or more of alkylammonium, arylammonium, imidazolium, derivatives of said imidazolium, pyridinium, derivatives of said pyridinium, choline, derivatives of said choline, morpholinium, derivatives of said morpholinium, phosphonium, derivatives of said phosphonium, an organic cation, a cation capable of forming an ionic liquid, and any combination thereof.

43. The method of claim 32, wherein a total concentration of all forms of said aqueous multi-electron oxidant in said one or more forms of said oxidant fluid supplied to said discharge unit of said discharge system is above one of 1 M, 2 M, 5 M, and 10 M.

44. The method of claim 32, wherein a concentration of said acidic protons in said oxidant fluid supplied to said discharge unit of said discharge system is below one of 0.01 M, 0.05 M, 0.1 M, 0.5 M, and 1 M.

45. The method of claim 32, wherein a concentration of said acidic protons in said oxidant fluid stored in said discharge system is below one of 0.01 M, 0.05 M, 0.1 M, 0.5 M, and 1 M.

46. The method of claim 32, wherein said transfer of said electrons from said negative electrode to said positive electrode of said electrolyte-electrode assembly through said external electric circuit is performed at a high current density and at low flow rates in an ignition mode of operation of said discharge system.

47. The method of claim 32, wherein said one or more forms of said discharge fluid comprise one or more of water, a halide, one or more forms of a buffer, an extra acid, a counter anion of an extra acid, and one or more counter cations.

48. The method of claim 32, wherein pH of said alkaline discharge fluid is one of between 4 and 12 and between 6 and 10.

49. The method of claim 32, wherein said one or more forms of said oxidant fluid comprise one or more of an acid form, a neutral form, an alkaline form, a partially acidic form, and a partially alkaline form.

50. The method of claim 32, wherein said reducer is hydrogen.

51. The method of claim 32, wherein said reducer comprises one or more of ammonia, hydrazine, hydroxylamine, phosphine, methane, a hydrocarbon, an alcohol, an aldehyde, a carbohydrate, a hydride, an oxide, a sulfide, an organic compound, an inorganic compound, and any combination thereof, with one of each other, hydrogen, water, and another solvent.

52. The method of claim 32, wherein said discharge is facilitated on said positive electrode of said electrolyte-electrode assembly by one or more of electrocatalysis, a solution-phase chemical reaction, a solution-phase comproportionation, a solution-phase redox catalysis, a solution-phase redox mediator, an acid-base catalysis, and any combination thereof.

53. The method of claim 32, wherein said discharge is facilitated via a solution-phase comproportionation of said aqueous multi-electron oxidant with a final product of a reduction of said aqueous multi-electron oxidant.

54. The method of claim 53, wherein said solution-phase comproportionation is pH-dependent and said discharge is facilitated in a presence of said acidic protons.

55. The method of claim 54, wherein said acidic protons are produced on said negative electrode and transferred to said positive electrode with said oxidant fluid across said electrolyte.

56. The method of claim 32, further comprising optimizing and stabilizing pH of said one or more forms of said discharge fluid in said splitting-disproportionation reactor of said regeneration system using a buffer present in one of said oxidant fluid, said discharge fluid, and a combination thereof, to facilitate said disproportionation of said intermediate oxidant into said aqueous multi-electron oxidant.

57. The method of claim 56, wherein said buffer in one of its forms is one or more of a dihydrogen phosphate, a 3-(N-morpholino)propanesulfonate, a 2-(N-morpholino)ethanesulfonate, another ω-(N-morpholino)alkanesulfonate, a substituted phosphonate, a molecule comprising sulfonic moieties and phosphonic acid moieties, an amine, a heterocyclic compound, and a compound capable of buffering solution pH between 4 and 12 and between 6 and 10.

58. The method of claim 32, wherein a concentration of said acidic protons in said discharge fluid is below one of 0.01 M, 0.05 M, and 0.1 M.

59. The method of claim 32, wherein said splitting of said alkaline discharge fluid into said reducer and said intermediate oxidant in said splitting-disproportionation reactor of said regeneration system is performed via one of electrolysis, photolysis, photoelectrolysis, radiolysis, thermolysis, and any combination thereof.

60. The method of claim 59, wherein said photolysis and said photoelectrolysis of said alkaline discharge fluid are performed in one of a presence and an absence of one of a light adsorbing facilitator, a semiconductor, a catalyst, and any combination thereof.

61. The method of claim 32, wherein said splitting-disproportionation reactor of said regeneration system is configured as an electrolysis-disproportionation reactor for said aqueous multi-electron oxidant-on-negative electrode approach using a multilayer structure on a negative electrode side of said electrolysis-disproportionation reactor.

62. The method of claim 61, wherein said multilayer structure on said negative electrode side of said electrolysis-disproportionation reactor is configured to minimize reduction of a regenerated aqueous multi-electron oxidant in a regenerated oxidant fluid on said negative electrode side while facilitating hydrogen evolution and an increase in pH of said regenerated oxidant fluid.

63. The method of claim 32, wherein said splitting-disproportionation reactor of said regeneration system is configured as an electrolysis-disproportionation reactor for said no-aqueous multi-electron oxidant-on-negative electrode approach by transferring a base produced on one or more negative electrodes of said electrolysis-disproportionation reactor to a regenerated oxidant fluid produced at one or more positive electrodes of said electrolysis-disproportionation reactor and comprising one of said intermediate oxidant and said discharge product of said aqueous multi-electron oxidant.

64. The method of claim 32, wherein a salt form of said aqueous multi-electron oxidant is one of lithium bromate, lithium chlorate, calcium bromate, calcium chlorate, magnesium bromate, magnesium chlorate, halates of other alkali metals, halates of other alkaline earth metals, halates of rare earth metals, halates of aluminum, halates of gallium, halates of indium, halates of thallium, halates of other cations with a pKa of hydroxide between 5 and 12, halates of organic cations, other salts of halogen oxoanions, and any combination thereof.
